(19) United States
(12) Patent Application Publication
(10) Pub. No.: US 2025/0278240 A1
(43) Pub. Date: Sep. 4, 2025

(54) Speech Recognition Using Active Acoustic Sensing

(71) Applicant: Google LLC, Mountain View, CA (US)

(72) Inventors: Patrick Muller Amihood, Palo Alto, CA (US); Cody Wortham, San Francisco, CA (US); Xiaoran Fan, Irvine, CA (US)

(73) Assignee: Google LLC, Mountain View, CA (US)

(21) Appl. No.: 19/055,080

(22) Filed: Feb. 17, 2025

Related U.S. Application Data
(60) Provisional application No. 63/559,576, filed on Feb. 29, 2024.

(51) Int. Cl. G06F 3/16; G01S 15/88; G10L 15/22

(52) U.S. Cl. CPC G06F 3/167; G01S 15/88; G10L 15/22

(57) ABSTRACT

Techniques and apparatuses are described that perform speech recognition using active acoustic sensing. During active acoustic sensing, a hearable transmits and receives at least one ultrasound signal, which propagates within a user's ear canal. This ultrasound signal can be modulated by a user's speech as well as by other muscle movements associated with speech (e.g., jaw movement and/or tongue movement). As such, the ultrasound signal contains information that is correlated with speech as well as additional contextual information in how the user created the speech using their body. With active acoustic sensing, the hearable can directly perform speech recognition based on the ultrasound signal and/or enhance speech recognition by fusing information derived from the ultrasound signal with information derived from an audible signal that is passively sensed using a microphone.

### CROSS-REFERENCE TO RELATED APPLICATION(S)

This application claims the benefit of U.S. Provisional Patent Application Ser. No. 63/559,576, filed on Feb. 29, 2024, the disclosure of which is incorporated by reference herein in its entirety.

### BACKGROUND

Wireless technology has become prevalent in everyday life, making communication and data readily accessible to users. One type of wireless technology are wireless hearables, examples of which include wireless earbuds and wireless headphones. Wireless hearables have allowed users freedom of movement while listening to audio content from music, audio books, podcasts, and videos. With the prevalence of wireless hearables, there is a market for adding additional features to existing hearables without introducing hardware changes.

### SUMMARY

Techniques and apparatuses are described for performing speech recognition using active acoustic sensing. During active acoustic sensing, a hearable transmits and receives at least one ultrasound signal, which propagates within a user's ear canal. This ultrasound signal can be modulated by a user's speech as well as by other muscle movements associated with speech (e.g., jaw movement). As such, the ultrasound signal contains information that is correlated with speech as well as additional contextual information in how the user created the speech using their body. With active acoustic sensing, the hearable can directly perform speech recognition based on the ultrasound signal and/or enhance speech recognition by fusing information derived from the ultrasound signal with information derived from an audible signal that is passively sensed using a microphone.

Aspects described below include a method for performing speech recognition using active acoustic sensing. The method includes transmitting, during a first time period, an ultrasound transmit signal that propagates within at least a portion of an ear canal of a user. The method also includes receiving, during the first time period, an ultrasound receive signal. The ultrasound receive signal represents a version of the ultrasound transmit signal with one or more characteristics modified based on the propagation within the ear canal and based on the user speaking a phrase during at least a portion of the first time period. The method additionally includes recognizing the spoken phrase based on the ultrasound receive signal. The method can optionally include generating a control signal that controls an operation of a device based on the recognized spoken phrase or converting the recognized spoken phrase to text.

Aspects described below include a computer-readable storage medium comprising instructions that, responsive to execution by a processor, cause a hearable to perform any one of the methods described herein.

Aspects described below include a device with at least one transducer and at least one processor. The device is configured to perform, using the at least one transducer and the at least one processor, any one of the methods described herein.

Aspects described below include a system with means for performing speech recognition using active acoustic sensing.

### BRIEF DESCRIPTION OF DRAWINGS

Apparatuses for and techniques that perform speech recognition using active acoustic sensing are described with reference to the following drawings. The same numbers are used throughout the drawings to reference like features and components:

FIG. 1 illustrates an example environment in which speech recognition using active acoustic sensing can be implemented;

FIG. 2 illustrates an example environment in which speech recognition using active acoustic sensing can be implemented;

FIG. 3 illustrates example components of a computing device;

FIG. 4 illustrates example components of a hearable;

FIG. 5 illustrates example operations of two hearables;

FIG. 6 illustrates an example implementation of a hearable capable of performing speech recognition using active acoustic sensing;

FIG. 7 illustrates example components of a speech-recognition module for performing aspects of speech recognition using active acoustic sensing;

FIG. 8 illustrates a first example implementation of a speech-recognition module;

FIG. 9 illustrates a second example implementation of a speech-recognition module;

FIG. 10 illustrates an impact of a first spoken phrase on an ultrasound receive signal;

FIG. 11 illustrates an impact of a second spoken phrase on an ultrasound receive signal;

FIG. 12 illustrates an impact of a third spoken phrase on an ultrasound receive signal;

FIG. 13 illustrates an example method for performing speech recognition using active acoustic sensing;

FIG. 14 illustrates another example method for performing speech recognition using active acoustic sensing; and

FIG. 15 illustrates an example computing system embodying, or in which techniques may be implemented that enable use of, speech recognition using active acoustic sensing.

### DETAILED DESCRIPTION

As electronic devices become more ubiquitous, users incorporate them into everyday life. A user, for example, may use an electronic device to get daily weather and traffic information, control a temperature of a home, answer a doorbell, turn on or off a light, and/or play background music. Interacting with some electronic devices, however, can be cumbersome and inefficient. An electronic device, for instance, can have a physical user interface that may require a user to navigate through one or more prompts by physically touching the electronic device. In this case, the user has to devote attention away from other primary tasks to interact with the electronic device, which can be inconvenient and disruptive.

To address this problem, some electronic devices support voice control, which enables a user to interact with the electronic device in a non-physical and less cognitively demanding way compared to other interfaces that require physical touch and/or the user's visual attention. With voice control, the electronic device seamlessly exists in the surrounding environment and provides the user access to information and services while the user performs a primary task, such as cooking, cleaning, driving, talking with people, or reading a book. For voice control, the electronic device detects a user's speech and recognizes a phrase (or command) that is spoken by the user.

While voice control can provide a convenient means of interacting with an electronic device, there are several challenges associated with performing speech recognition. In a noisy environment, for instance, the user's voice can be made imperceptible by the other external noise. Consequently, it can be challenging to detect and/or recognize phrases spoken by the user. Also, sometimes the noisy environment can cause the voice control to incorrectly respond to a voice of another person who is not authorized to use the electronic device. Although it may be easier to perform speech recognition in a quiet environment, the quiet environment can pose other challenges. In a library or a classroom, for instance, it may be inappropriate and/or socially awkward to speak audibly. As such, a user may forego the use of voice control in these types of situations.

To improve aesthetics and reduce encumbrance, it can be desirable to design hearables with smaller sizes. As space becomes limited, it can be challenging to integrate additional components, such as the voice accelerometer, within the hearables. With the prevalence of hearables, there is a market for adding additional features to existing hearables to facilitate speech recognition without introducing hardware changes.

Provided according to one or more preferred embodiments is a hearable, such as an earbud, that is capable of performing a novel physiological monitoring process termed herein audioplethysmography. Audioplethysmography is an active acoustic method capable of sensing subtle physiologically-related changes observable at a user's outer and middle ear. Instead of relying on other auxiliary sensors, such as optical or electrical sensors, audioplethysmography involves transmitting and receiving ultrasound signals that at least partially propagate within a user's ear canal. To perform audioplethysmography, the hearable forms at least a partial seal in or around the user's outer ear. This seal enables formation of an acoustic circuit, which includes the seal, the hearable, the ear canal, and an ear drum of the ear. By transmitting and receiving ultrasound signals, the hearable can recognize changes in the acoustic circuit to perform speech recognition. Speech recognition involves identifying a phrase that is spoken by the user. The phrase can include any sound that is produced using the user's lung's, vocal cords, and/or mouth. Example types of vocalizations can involve the user speaking, whispering, shouting, humming, whistling, singing, or making other utterances.

During active acoustic sensing, a hearable transmits and receives at least one ultrasound signal, which propagates within the user's ear canal. This ultrasound signal can be modulated by a user's speech as well as by other muscle movements associated with speech (e.g., jaw movement). As such, the ultrasound signal contains information that is correlated with speech as well as additional contextual information in how the user created the speech using their body. With active acoustic sensing, the hearable can directly perform speech recognition based on the ultrasound signal and/or enhance speech recognition by fusing information derived from the ultrasound signal with information derived from an audible signal that is passively sensed using a microphone.

Utilizing active acoustic sensing for speech recognition can provide several benefits. In a first aspect, active acoustic sensing enables the hearable to support a discrete version of voice control that involves silent speech. With silent speech, the user can perform the muscle movements associated with speaking without producing an audible sound. In this case, speech recognition using active acoustic sensing provides a discreet and socially acceptable means of controlling a device in various environments. This feature can be particularly advantageous in environments, such as a library or a classroom, where it may be inappropriate and/or socially awkward to speak audibly.

In a second aspect, active acoustic sensing can further improve speech recognition in a noisy and/or loud environment. This is because the ultrasound signal associated with active acoustic sensing is less susceptible to noise that is present in an external environment compared to an over-the-air audible signal. In a third aspect, active acoustic sensing can provide additional contextual information that can improve speech recognition for users who have difficulty speaking, including those having a motor speech disorder (e.g., dysarthria). In addition to being relatively unobtrusive, some hearables can be configured to support speech recognition using active acoustic sensing without the need for additional hardware. As such, the size, cost, and power usage of the hearable can help make speech recognition accessible to a larger group of people and improve the user experience with hearables.

Active acoustic sensing can improve the performance of speech recognition relative to other sensing techniques. Techniques that involve a non-wearable electronic device capable of observing the user's jaw movement using ultrasound, for instance, may not be as sensitive or as accurate compared to active acoustic sensing. This is in part because active acoustic sensing can be performed using a hearable that is worn by the user, which enables the user's vocalization to be directly measured based on a pressure wave that propagates to the user's ear. In contrast, observing the user's jaw movement with ultrasound may only work in limited circumstances in which the user is properly oriented relative to the electronic device and the electronic device has an unobstructed line-of-sight to the user's face to observe the jaw movement. Still other techniques utilize a microphone to detect voice through bone conduction. While this passive technique can provide some additional information associated with speech, the information is limited to the low frequency band, which can include frequencies below 1.5 kilohertz (kHz). In contrast, active acoustic sensing can provide feature-rich information associated with both the low frequency band (e.g., below 1.5 kHz) and a high frequency band (e.g., above 1.5 kHz).

### Operating Environment

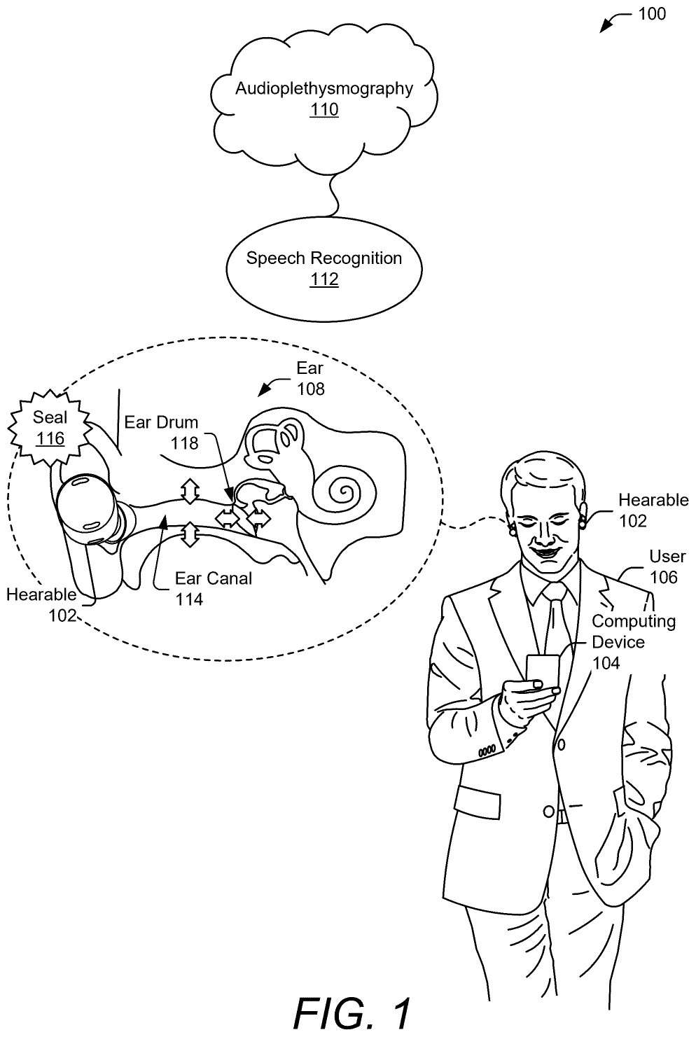

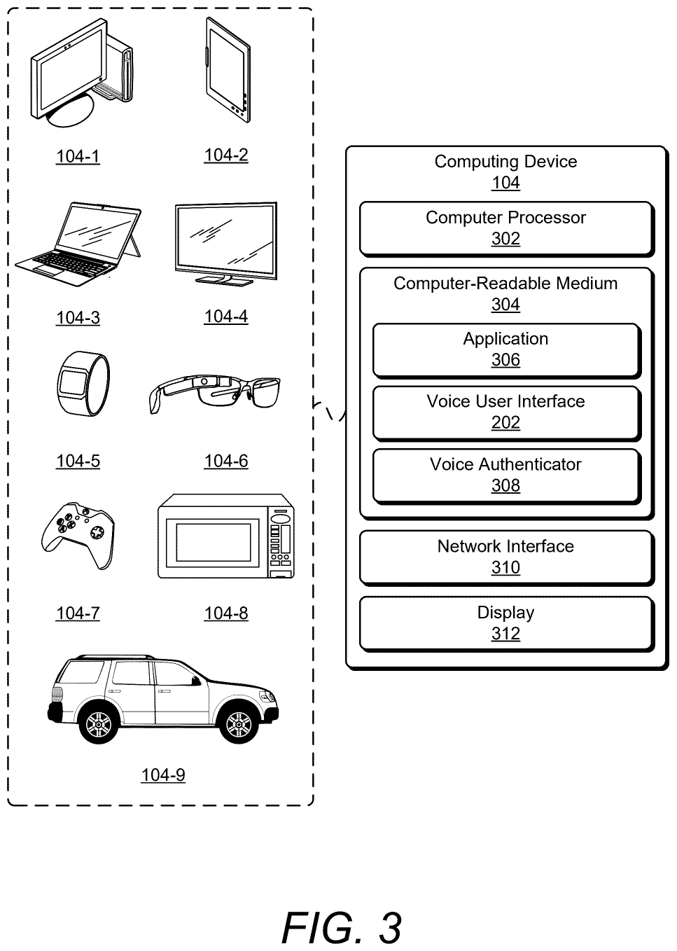

FIG. 1 is an illustration of an example environment 100 in which active acoustic sensing can be implemented. In the example environment 100, a hearable 102 is connected to a computing device 104 using a physical or wireless interface. The hearable 102 is a device that can play audible content provided by the computing device 104 and direct the audible content into a user 106's ear 108. In this example, the hearable 102 operates together with the computing device 104. In other examples, the hearable 102 can operate or be implemented as a stand-alone device. Although depicted as a smartphone, the computing device 104 can include other types of devices, including those described with respect to FIG. 3.

The hearable 102 is capable of performing audioplethysmography 110, which is an active acoustic method of sensing that occurs at the ear 108. The hearable 102 can perform this sensing without the use of other auxiliary sensors, such as an optical sensor or an electrical sensor. Through audioplethysmography 110, the hearable 102 can perform speech recognition 112. Speech recognition 112 enables the hearable 102 (or the computing device 104) to recognize one or more phrases that are spoken by the user 106. A phrase can involve any type of vocalization associated with speaking, whispering, shouting, humming, whistling, singing, or other utterances. The phrase can include a single word or multiple words. Generally speaking, speech recognition 112 can also be referred to as automatic speech recognition (ASR), computer speech recognition, or speech-to-text (STT). Two types of speech recognition 112 are further described below. The techniques for performing speech recognition 112 through active acoustic sensing can generally be performed using a hearable 102 that is worn in or on an ear of any person.

A first type of speech recognition 112 is referred to as ultrasound-based speech recognition. Ultrasound-based speech recognition involves speech recognition 112 that can be directly performed using one or more signals derived from the ultrasound signals associated with audioplethysmography 110. This type of speech recognition 112 can be performed without the use of passive audio sensing (e.g., without generating an audio signal that represents an audible over-the-air signal). Also, ultrasound-based speech recognition can be performed without relying on other types of sensors (e.g., sensors that do not utilize ultrasound), such as a voice accelerometer. With ultrasound-based speech recognition, the user 106 can optionally speak a phrase with minimal or no sound (e.g., by whispering and/or by performing silent speech). Other speech recognition techniques that rely on passive audio sensing may be unable to support silent speech as there is an absence of audible sound.

A second type of speech recognition 112 is referred to as ultrasound-fusion speech recognition. Ultrasound-fusion speech recognition involves speech recognition 112 that can be performed using a combination of information derived from audioplethysmography 110 and information derived from passive audio sensing. This fusion can enhance the performance of speech recognition 112 in noisy and/or loud environments relative to other techniques that do not utilize information derived from audioplethysmography 110. It can also support the use of silent speech. In some cases, ultrasound-fusion speech recognition can obviate the use of other sensors, such as a voice accelerometer. In addition to enabling the hearable 102 to be implemented without these other sensors, which can be bulky and/or expensive, audioplethysmography 110 can be less susceptible to noise caused by the user moving (e.g., walking or running). As such, audioplethysmography 110 can further enhance the performance of speech recognition while the user is moving relative to other types of sensors.

To perform speech recognition 112, the hearable 102 uses audioplethysmography 110 to detect subtle pressure waves that propagate to the user 106's ear canal 114. These pressure waves modify characteristics of ultrasound signals that are transmitted and received by the hearable 102 and propagate through the ear canal 114. As the user 106 speaks, the ear canal 114 deforms at least in part due to the speech itself and at least in part due to the muscle movements associated with performing the speech. As such, at least a portion of the received ultrasound signal includes information that is correlated with the user 106's speech and at least another portion of the received ultrasound signal includes other information that is correlated with muscle movements associated with generating the speech. In some cases, the user 106's speech can be directly reconstructed from the received ultrasound signal.

To use audioplethysmography 110, the user 106 positions the hearable 102 in a manner that creates at least a partial seal 116 around or in the ear 108. Some parts of the ear 108 are shown in FIG. 1, including the ear canal 114 and an ear drum 118 (or tympanic membrane). Due to the seal 116, the hearable 102, the ear canal 114, and the ear drum 118 couple together to form an acoustic circuit. Audioplethysmography 110 involves, at least in part, measuring properties associated with this acoustic circuit. The properties of the acoustic circuit can change due to a variety of different situations or actions.

For example, consider a change that occurs in a physical structure of the ear 108. Example changes to the physical structure include a change in a geometric shape of the ear canal 114 and/or a change in a volume of the ear canal 114. This change can be caused, at least in part, by a pressure wave associated with the user 106's speech. For instance, the tissue around the ear canal 114 and the ear drum 118 itself are slightly “squeezed” due to the bone conduction and/or the pressure wave. This squeeze causes a volume of the ear canal 114 to be slightly reduced. As the squeezing subsides, the volume of the ear canal 114 is slightly increased. The increasing and decreasing of the volume of the ear canal 114 is indicated by the arrows in FIG. 1. The physical changes within the ear 108 can modulate an amplitude and/or phase of an ultrasound signal that propagates through the ear canal 114.

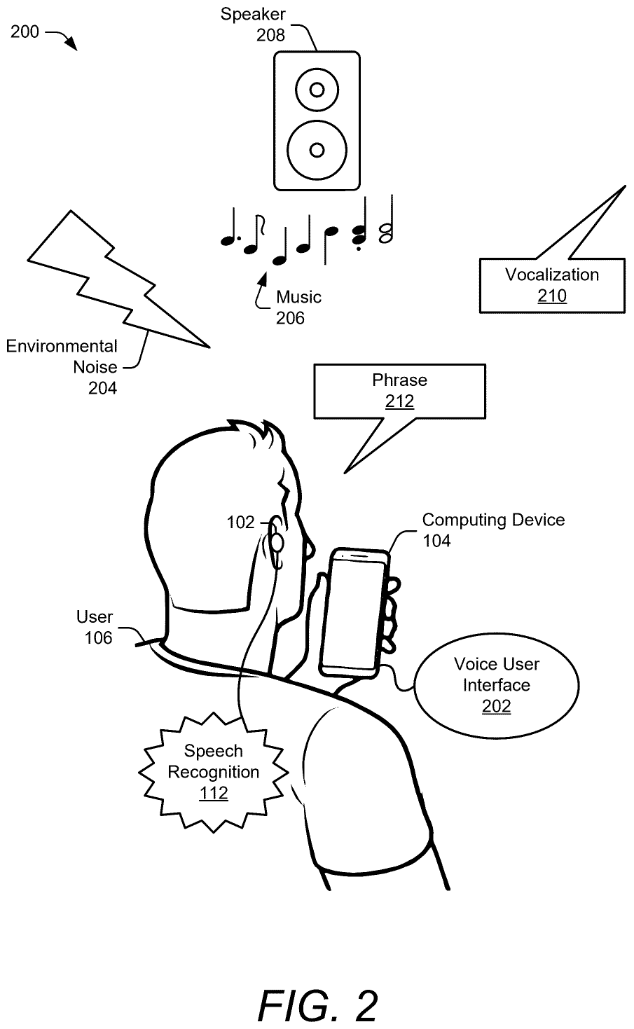

The techniques for audioplethysmography 110 can be performed while the hearable 102 is rendering (e.g., playing or transmitting) audible content and/or while the user 106 is actively moving or performing an activity. As such, active acoustic sensing enables the hearable 102 to perform speech recognition 112 in a variety of different situations. One such situation is further described with respect to FIG. 2.

FIG. 2 illustrates an example environment 200 in which speech recognition 112 using active acoustic sensing can be implemented. The environment 200 represents a noisy and/or loud environment that includes a variety of audible signals. These audible signals propagate over-the-air and can make it challenging for the user 106 to utilize a voice user interface 202 of the computing device 104. Example noise sources include environmental noise 204, music 206 played by a speaker 208, a vocalization 210 made by another person, or some combination thereof.

The noise sources can make it challenging for the voice user interface 202 to detect and/or recognize a phrase 212 that is spoken by the user 106. In some cases, the phrase 212 can be a voiceprint phrase or a voice command. The voiceprint phrase can be a unique phrase that enables the user 106 to be identified and authenticated for voice-control access. The voice command is another unique phrase that can be used to control the hearable 102 and/or the computing device 104.

To address this problem, the user 106 speaks the phrase 212 while wearing the hearable 102. With speech recognition 112, the hearable 102 can identify the phrase 212 and pass this information to the voice user interface 202 of the computing device 104. Additionally or alternatively, speech recognition 112 can be used to support other applications of the computing device 104, as further described with respect to FIG. 3.

FIG. 3 illustrates an example implementation of the computing device 104. The computing device 104 is illustrated with various non-limiting example devices including a desktop computer 104-1, a tablet 104-2, a laptop 104-3, a television 104-4, a computing watch 104-5, computing glasses 104-6, a gaming system 104-7, a microwave 104-8, and a vehicle 104-9. Other devices may also be used, such as an augmented and/or virtual reality headset, a home service device, a smart speaker, a smart thermostat, a baby monitor, a Wi-Fi™ router, a drone, a trackpad, a drawing pad, a netbook, an e-reader, a home automation and control system, a wall display, and another home appliance. Note that the computing device 104 can be wearable, non-wearable but mobile, or relatively immobile (e.g., desktops and appliances).

The computing device 104 includes one or more computer processors 302 and at least one computer-readable medium 304, which includes memory media and storage media. Applications and/or an operating system (not shown) embodied as computer-readable instructions on the computer-readable medium 304 can be executed by the computer processor 302 to provide some of the functionalities described herein. The computer-readable medium 304 can optionally include an application 306, the voice user interface 202, and/or a voice authenticator 308. Additionally or alternatively, the computer-readable medium 304 can include other types of applications that utilize speech recognition 112, such as a translation service that converts speech to text.

The application 306 can use information provided by the hearable 102 to perform an action. Example actions can include displaying data associated with audioplethysmography 110 to the user 106. For speech recognition 112, the application 306 can indicate whether or not the phrase 212 is recognized. The voice user interface 202 can enable the user 106 to control the computing device 104 via voice commands, as described with respect to FIG. 2. The voice authenticator 308 can authenticate the user 106 and enable use of the voice user interface 202 upon successful authentication. The application 306, the voice user interface 202, and/or the voice authenticator 308 can utilize aspects of speech recognition 112 to provide certain features and/or enhance security of the computing device 104.

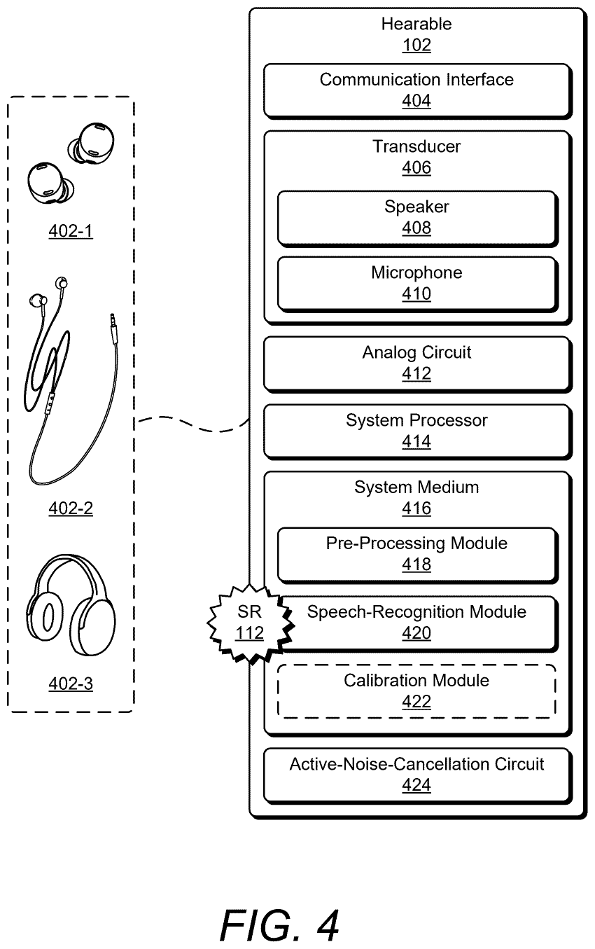

The computing device 104 can also include a network interface 310 for communicating data over wired, wireless, or optical networks. For example, the network interface 310 may communicate data over a local-area-network (LAN), a wireless local-area-network (WLAN), a personal-area-network (PAN), a wire-area-network (WAN), an intranet, the Internet, a peer-to-peer network, point-to-point network, a mesh network, Bluetooth®, and the like. The computing device 104 may also include the display 312. Although not explicitly shown, the hearable 102 can be integrated within the computing device 104, or can connect physically or wirelessly to the computing device 104. The hearable 102 is further described with respect to FIG. 4.

FIG. 4 illustrates an example hearable 102. The hearable 102 is illustrated with various non-limiting example devices, including wireless earbuds 402-1, wired earbuds 402-2, and headphones 402-3. The earbuds 402-1 and 402-2 are a type of in-ear device that fits into the ear canal 114. Each earbud 402-1 or 402-2 can represent a hearable 102. Headphones 402-3 can rest on top of or over the ears 108. The headphones 402-3 can represent closed-back headphones, open-back headphones, on-ear headphones, or over-ear headphones. Each headphone 402-2 includes two hearables 102, which are physically packaged together. In general, there is one hearable 102 for each ear 108. The headphones 402-3 may be designed in some manner or may utilize techniques, such as beamforming, to assist with directing signals used for audioplethysmography 110 into the ear canal 114.

The hearable 102 includes a communication interface 404 to communicate with the computing device 104, though this need not be used when the hearable 102 is integrated within the computing device 104. The communication interface 404 can be a wired interface or a wireless interface, in which audio content is passed from the computing device 104 to the hearable 102. The hearable 102 can also use the communication interface 404 to pass data associated with audioplethysmography 110 and/or speech recognition 112 to the computing device 104. In general, the data provided by the communication interface 404 is in a format usable by the application 306, the voice user interface 202, the voice authenticator 308, or another application of the computing device 104.

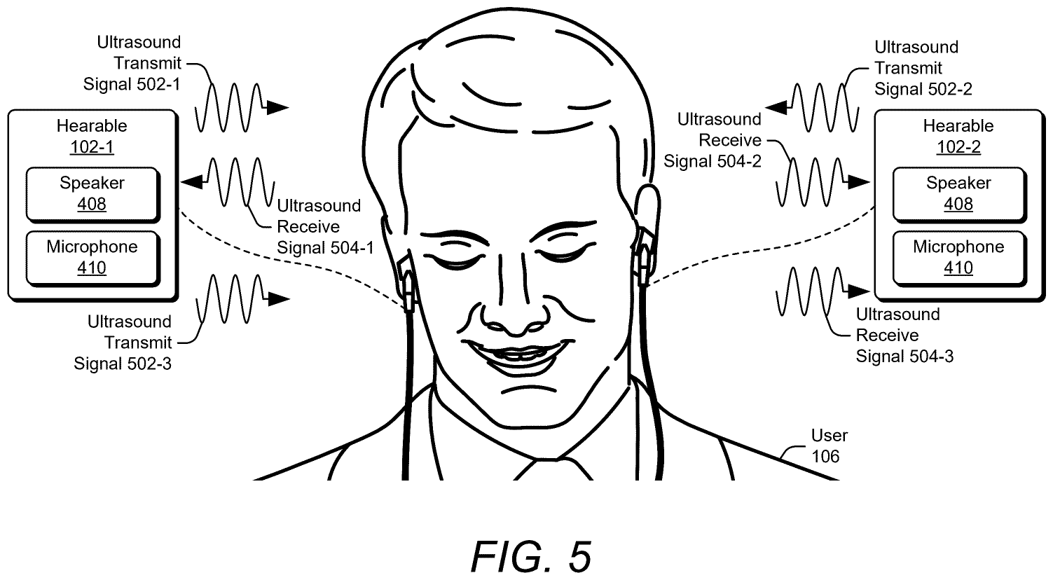

The communication interface 404 also enables the hearable 102 to communicate with another hearable 102. During bistatic sensing, for instance, the hearable 102 can use the communication interface 404 to coordinate with the other hearable 102 to support two-ear audioplethysmography 110, as further described with respect to FIG. 5. In particular, the transmitting hearable 102 can communicate timing and waveform information to the receiving hearable 102 to enable the receiving hearable 102 to appropriately demodulate a received ultrasound signal.

The hearable 102 includes at least one transducer 406 that can convert electrical signals into sound waves. The transducer 406 can also detect and convert sound waves into electrical signals. These sound waves may include ultrasonic frequencies, which may be used for audioplethysmography 110. In particular, a frequency spectrum (e.g., range of frequencies) that the transducer 406 uses to generate an ultrasound signal can include frequencies from the ultrasonic range, e.g., between 20 kHz to 2 megahertz (MHz). Other example frequency spectrums for audioplethysmography 110 can encompass frequencies between 20 and 60 kHz or between 30 and 40 kHz.

In an example implementation, the transducer 406 has a monostatic topology. With this topology, the transducer 406 can convert the electrical signals into sound waves and convert sound waves into electrical signals (e.g., can transmit or receive acoustic and/or ultrasound signals). Example monostatic transducers may include piezoelectric transducers, capacitive transducers, and micro-machined ultrasonic transducers (MUTs) that use microelectromechanical systems (MEMS) technology.

Alternatively, the transducer 406 can be implemented with a bistatic topology, which includes multiple transducers that are physically separate. In this case, a first transducer converts the electrical signal into sound waves (e.g., transmits acoustic and/or ultrasound signals), and a second transducer converts sound waves into an electrical signal (e.g., receives the acoustic and/or ultrasound signals). An example bistatic topology can be implemented using at least one speaker 408 and at least one microphone 410. The speaker 408 and the microphone 410 can be dedicated for audioplethysmography 110 or can be used for both audioplethysmography 110 and other functions of the computing device 104 (e.g., passive audio sensing, presenting audible content to the user 106, capturing the user 106's voice for a phone call, or for voice control).

In general, the speaker 408 and the microphone 410 are directed towards the ear canal 114 (e.g., oriented towards the ear canal 114). Accordingly, the speaker 408 can direct ultrasound signals towards the ear canal 114, and the microphone 410 is responsive to receiving ultrasound signals from the direction associated with the ear canal 114. In some cases, the hearable 102 includes another microphone 410 that is directed away from the ear canal 114 towards an external environment (e.g., oriented away from the ear canal 114). This other microphone can be used to receive over-the-air signals, which can include the user 106's voice and/or environmental noise.

The hearable 102 includes at least one analog circuit 412, which includes circuitry and logic for conditioning electrical signals in an analog domain. The analog circuit 412 can include analog-to-digital converters, digital-to-analog converters, amplifiers, filters, mixers, and switches for generating and modifying electrical signals. In some implementations, the analog circuit 412 includes other hardware circuitry associated with the speaker 408 or microphone 410.

The hearable 102 also includes at least one system processor 414 and at least one system medium 416 (e.g., one or more computer-readable storage media). In the depicted configuration, the system medium 416 includes a pre-processing module 418 and a speech-recognition module 420. The system medium 416 also optionally includes a calibration module 422. The pre-processing module 418, the speech-recognition module 420, and the calibration module 422 can be implemented using hardware, software, firmware, or a combination thereof. In this example, the system processor 414 implements the pre-processing module 418, the speech-recognition module 420, and the calibration module 422. In an alternative example, the computer processor 302 of the computing device 104 can implement at least a portion of the pre-processing module 418, the speech-recognition module 420, and/or the calibration module 422. In this case, the hearable 102 can communicate digital samples of the acoustic and/or ultrasound signals to the computing device 104 using the communication interface 404.

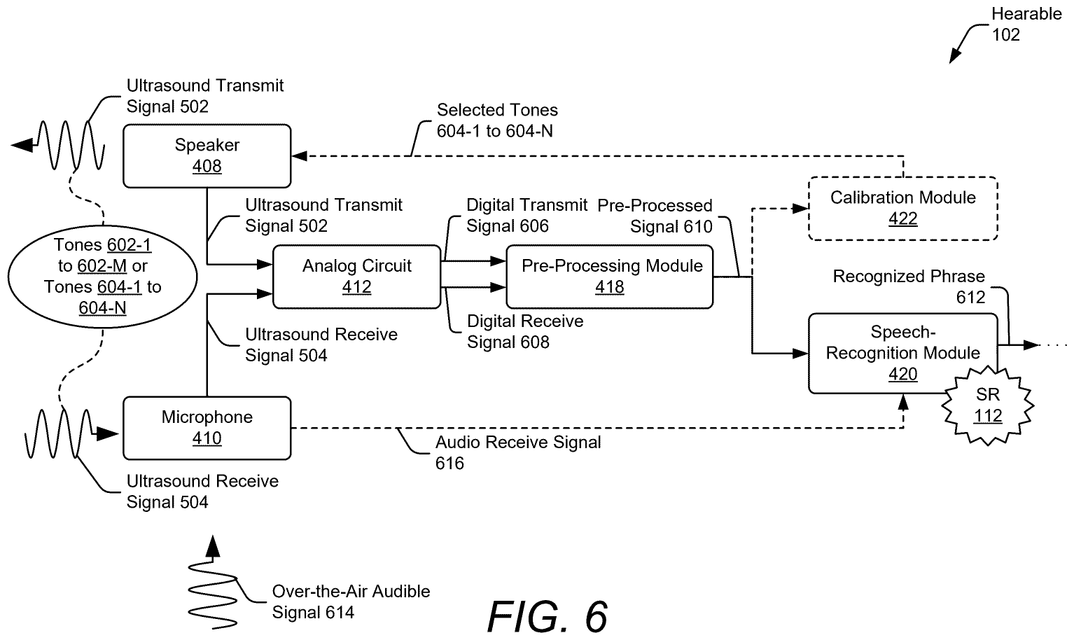

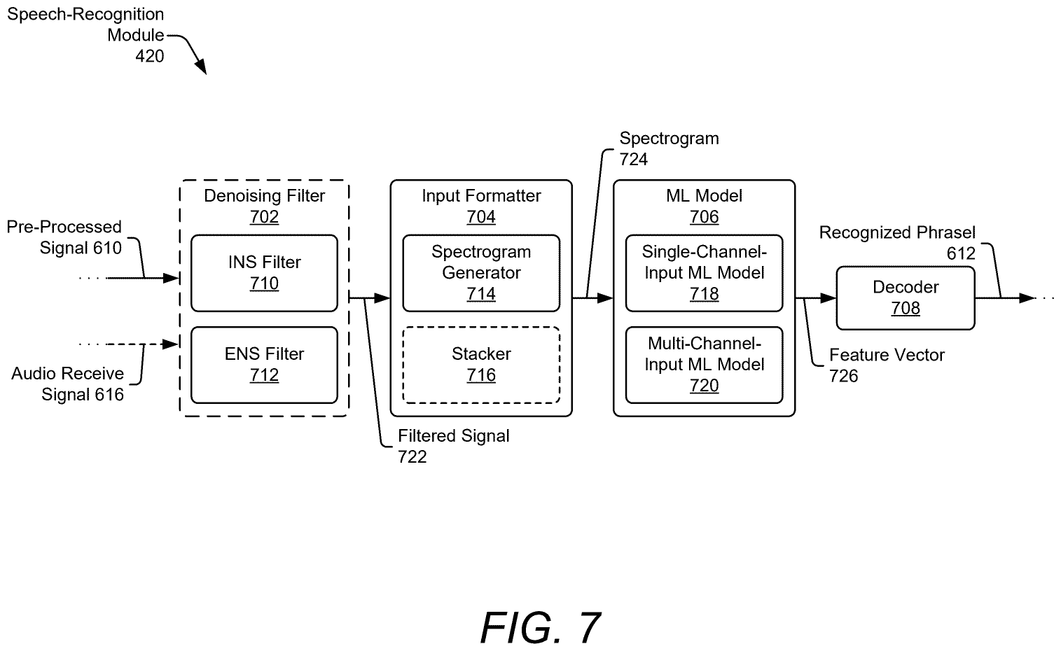

Operations of the pre-processing module 418, the speech-recognition module 420, and the calibration module 422 are further described with respect to FIG. 6. Aspects of speech recognition 112 using active acoustic sensing can be performed, at least partially, by the speech-recognition module 420, as further described with respect to FIG. 7.

Some hearables 102 include an active-noise-cancellation circuit 424, which enables the hearables 102 to reduce background or environmental noise. In this case, the microphone 410 used for audioplethysmography 110 can be implemented using a feedback microphone of the active-noise-cancellation circuit 424. During active noise cancellation, the feedback microphone provides feedback information regarding the performance of the active noise cancellation. During audioplethysmography 110, the feedback microphone receives an ultrasound signal, which is provided to the pre-processing module 418. In some situations, active noise cancellation and audioplethysmography 110 are performed simultaneously using the feedback microphone. In this case, the ultrasound signal received by the feedback microphone can be provided to the pre-processing module 418 and the feedback signal for active noise cancellation can be provided to the active-noise-cancellation circuit 424. Other implementations are also possible in which the microphone 410 is implemented using a feedforward microphone of the active-noise-cancellation circuit 424. In some implementations, the feedforward microphone performs passive audio sensing to provide an audio signal for denoising operations and/or for aspects of ultrasound-fusion speech recognition.

Although not explicitly shown in FIG. 4, the system medium 416 can also include a voice user interface 202, a voice authenticator 308, and/or another application that utilizes speech recognition 112. In this case, the voice user interface 202 enables the user 106 to use voice controls to control an operation of the hearable 102. The voice authenticator 308 can authenticate the user 106 and enable the voice user interface 202 for the hearable 102. Different types of audioplethysmography 110 are further described with respect to FIG. 5.

### Active Acoustic Sensing

FIG. 5 illustrates example operations of two hearables 102-1 and 102-2. In a first example operation, the hearables 102-1 and 102-2 perform single-ear audioplethysmography 110. This means that the hearables 102-1 and 102-2 independently perform audioplethysmography 110 on different ears 108 of the user 106. In this case, the first hearable 102-1 is proximate to the user 106's right ear 108, and the second hearable 102-2 is proximate to the user 106's left ear 108. Each hearable 102-1 and 102-2 includes a speaker 408 and a microphone 410. The hearables 102-1 and 102-2 can operate in a monostatic manner during the same time period or during different time periods. In other words, each hearable 102-1 and 102-2 can independently transmit and receive ultrasound signals.

For example, the first hearable 102-1 uses the speaker 408 to transmit a first ultrasound transmit 502-1, which propagates within at least a portion of the user 106's right ear canal 114. The first hearable 102-1 uses the microphone 410 to receive a first ultrasound receive signal 504-1. The first ultrasound receive signal 504-1 represents a version of the first ultrasound transmit signal 502-1 that is modified, at least in part, by the acoustic circuit associated with the right ear canal 114. This modification can change an amplitude, phase, and/or frequency of the first ultrasound receive signal 504-1 relative to the first ultrasound transmit signal 502-1.

Similarly, the second hearable 102-2 uses the speaker 408 to transmit a second ultrasound transmit signal 502-2, which propagates within at least a portion of the user 106's left ear canal 114. The second hearable 102-2 uses the microphone 410 to receive a second ultrasound receive signal 504-2. The second ultrasound receive signal 504-2 represents a version of the second ultrasound transmit signal 502-2 that is modified by the acoustic circuit associated with the left ear canal 114. This modification can change an amplitude, phase, and/or frequency of the second ultrasound receive signal 504-2 relative to the second ultrasound transmit signal 502-2.

The techniques of single-ear audioplethysmography 110 can be particularly beneficial as it enables the computing device 104 to compile information from both hearables 102-1 and 102-2, which can further improve measurement confidence. For some aspects of audioplethysmography 110, it can be beneficial to analyze the acoustic channel between two ears 108, as further described below.

In a second example operation, the two hearables 102-1 and 102-2 perform two-ear audioplethysmography 110. This means that the hearables 102-1 and 102-2 jointly perform audioplethysmography 110 across two ears 108 of the user 106. In this case, at least one of the hearables 102 (e.g., the first hearable 102-1) includes the speaker 408, and at least one of the other hearables 102 (e.g., the second hearable 102-2) includes the microphone 410. The hearables 102-1 and 102-2 operate together in a bistatic manner during the same time period.

During operation, the first hearable 102-1 transmits a third ultrasound transmit 502-3 using the speaker 408. The third ultrasound transmit signal 502-3 propagates through the user 106's right ear canal 114. The third ultrasound transmit signal 502-3 also propagates through an acoustic channel that exists between the right and left ears 108. In the left ear 108, the third ultrasound transmit signal 502-3 propagates through the user 106's left ear canal 114 and is represented as a third ultrasound receive signal 504-3. The second hearable 102-2 receives the third ultrasound receive signal 504-3 using the microphone 410. The third ultrasound receive signal 504-3 represents a version of the third ultrasound transmit signal 502-3 that is modified by the acoustic circuit associated with the right ear canal 114, modified by the acoustic channel associated with the user 106's face, and modified by the acoustic circuit associated with the left ear canal 114. This modification can change an amplitude, phase, and/or frequency of the third ultrasound receive signal 504-3 relative to the third ultrasound transmit signal 502-3. In some cases, the hearable 102-2 measures the time-of-flight (ToF) associated with the propagation from the first hearable 102-1 to the second hearable 102-2. Sometimes a combination of single-ear and two-ear audioplethysmography 110 are applied to further improve measurement confidence.

The ultrasound transmit signals 502 of FIG. 5 can represent a variety of different types of signals as described above with respect to FIG. 4. In example implementations, the ultrasound transmit signal 502 can be a continuous-wave signal (e.g., a sinusoidal signal) or a pulsed signal. Some ultrasound transmit signals 502 can have a particular tone (or frequency). Other ultrasound transmit signals 502 can have multiple tones (or multiple frequencies). A variety of modulations can be applied to generate the ultrasound transmit signal 502. Example modulations include linear frequency modulations, triangular frequency modulations, stepped frequency modulations, phase modulations, or amplitude modulations. The ultrasound transmit signal 502 can be transmitted as part of a calibration procedure or a measurement procedure, as further described as part of FIG. 6.

FIG. 6 illustrates an example implementation of the hearable 102 for performing speech recognition 112. In the depicted configuration, the hearable 102 includes the speaker 408, the microphone 410, the analog circuit 412, the pre-processing module 418, the speech-recognition module 420, and the calibration module 422. Other implementations of the hearable 102, however, are also possible in which the hearable 102 does not include the calibration module 422 to reduce processing power requirements. In this case, the pre-processing module 418 can perform aspects of frequency selection as further described below to improve the signal-to-noise ratio for audioplethysmography 110.

Outputs of the speaker 408 and the microphone 410 are coupled to inputs of the analog circuit 412. The pre-processing module 418 has inputs that are coupled to outputs of the analog circuit 412. The pre-processing module 418 also has an output that is coupled to inputs of the speech-recognition module 420 and the calibration module 422. In an example implementation, the pre-processing module 418 includes at least one in-phase and quadrature mixer (I/Q mixer) and at least one filter. The in-phase and quadrature mixer performs frequency down-conversion and can be implemented using at least two mixers, at least one phase shifter, and at least one combiner (e.g., a summation circuit). The filter attenuates intermodulation products that are generated by the in-phase and quadrature mixer. In an example implementation, the filter is implemented using a low-pass filter.

The pre-processing module 418 can optionally include at least one frequency selector. The frequency selector can identify and select one or more tones (or carrier frequencies) that provide a high-quality signal for later processing. The frequency selector can further pass the selected tones to other processing modules (e.g., the speech-recognition module 420) and filter (or attenuate) other tones that are not selected. The frequency selector can be implemented in a similar manner as the calibration module 422, which is further described below.

The speech-recognition module 420 can optionally have another input that is coupled to the microphone 410 (or another microphone not shown). Example implementations of the speech-recognition module 420 are further described with respect to FIGS. 7-9. With the speech-recognition module 420, the hearable 102 performs a measurement procedure that includes performing speech recognition 112 using audioplethysmography 110 (e.g., performing ultrasound-based speech recognition and/or ultrasound-fusion speech recognition).

The calibration module 422 has an output that is coupled to the speaker 408. The calibration module 422 includes at least one frequency selector. The frequency selector can include at least one amplitude detector, at least one phase detector, at least one quality detector, and at least one comparator. Using the frequency selector, the calibration module 422 can perform a calibration procedure that determines appropriate characteristics (e.g., waveform or signal characteristics) of ultrasound transmit signals 502 to improve audioplethysmography 110 (e.g., to enhance the performance of speech recognition 112). The calibration procedure enables audioplethysmography 110 to take into account the wear of the hearable 102 (e.g., the position of the hearable 102 relative to the ear canal 114) and the physical structure of the ear canal 114 to determine a transmission frequency that can increase sensitivity.

Consider an example operation of the hearable 102 in accordance with single-ear audioplethysmography 110. In this example, the hearable 102 includes the calibration module 422. With the calibration module 422, the hearable 102 can perform the calibration procedure prior to performing a measurement procedure. In some circumstances, the hearable 102 can perform on-head detection (or in-ear detection) by detecting the presence of the seal 116 and initiating the calibration procedure and/or the measurement procedure based on a determination that on-head detection is “true.” In other circumstances, the hearable 102 can initiate the calibration procedure based on a specified schedule or a timer, which can be controlled by the user 106 via the computing device 104. The calibration procedure and the measurement procedure are further described below.

During both the calibration procedure and the measurement procedure, the speaker 408 transmits the ultrasound transmit signal 502 and the microphone 410 receives the ultrasound receive signal 504. During the calibration procedure, the ultrasound transmit signal 502 and the ultrasound receive signal 504 can have tones 602-1 to 602-M, where M represents a positive integer. The multiple tones 602-1 to 602-M can be transmitted in parallel or in series over a given time interval. In this case, the ultrasound transmit signal 502 can have a particular bandwidth on the order of several kilohertz. For example, the ultrasound transmit signal 502 can have a bandwidth of approximately 4, 5, 6, 8, 10, 16, or 20 kHz. In example implementations, the ultrasound transmit signal 502 is transmitted over multiple seconds, such as 2, 3, 4, 6, or more seconds. A duration of each tone 602 can be evenly divided over a total duration of the ultrasound transmit signal 502.

In an example implementation, the ultrasound transmit signal 502 for the calibration procedure can have seven tones 602 (e.g., M equals 7). In some cases, the tones 602 are evenly distributed across an interval. For example, the tones 602 can be in 1 kHz increments between 32 kHz and 38 kHz (e.g., at approximately 32, 33, 34, 35, 36, 37, and 38 kHz). The term “approximately” means that the tones 602 can be within 5% of a given value or less (e.g., within 3%, 2%, or 1% of the given value).

An amplitude of the calibration procedure's ultrasound transmit signal 502 can be approximately the same across the tones 602-1 to 602-M. In this manner, power is evenly distributed across each tone 602. The quantity of tones 602 (e.g., M) can be determined based on an output power of the speaker 408. Increasing the quantity of tones 602 can increase a likelihood that the hearable 102 can support speech recognition 112 across various conditions including user wear and a physical structure of the user 106's ear canal 114. However, an amplitude of the ultrasound transmit signal 502 can be limited across these tones 602 based on the output power of the speaker 408. Thus, the quantity of tones 602 can be optimized based on an amount of output power that is available for audioplethysmography 110.

During the measurement procedure, the ultrasound transmit signal 502 and the ultrasound receive signal 504 can have selected tones 604-1 to 604-N, where N represents a positive integer that is less than or equal to M. The selected tones 604-1 to 604-N can represent a subset (sometimes a proper subset) of the tones 602-1 to 602-M. The selected tones 604 can be transmitted in parallel or in series over a given time interval.

An amplitude of the measurement procedure's ultrasound transmit signal 502 can be approximately the same across the selected tones 604-1 to 604-N. In this manner, power is evenly distributed across each selected tone. The amplitude of the measurement procedure's ultrasound transmit signal 502 can be higher than the amplitude of the calibration procedure's ultrasound transmit signal 502 because the available output power is distributed across fewer tones. Additionally or alternatively, a duration of each of the selected tones 604 of the measurement procedure's ultrasound transmit signal 502 can be longer than the duration of the tones 602 of the calibration procedure's ultrasound transmit signal 502. The higher amplitude and/or the longer duration can further improve the signal-to-noise ratio performance of the hearable 102 for audioplethysmography 110. By using a few selected tones 604 that were determined to improve signal-to-noise ratio performance, the measurement procedure can achieve a higher level of accuracy and sensitivity for speech recognition 112.

The analog circuit 412 performs analog-to-digital conversion to generate a digital transmit signal 606 and a digital receive signal 608 based on the ultrasound transmit signal 502 and the ultrasound receive signal 504, respectively. The pre-processing module 418 performs frequency downconversion and demodulation to generate at least one pre-processed signal 610 based on the digital transmit signal 606 and the digital receive signal 608. The pre-processing module 418 can also apply filtering to generate the pre-processed signal 610.

Optionally, as part of the calibration procedure, the calibration module 422 processes the pre-processed signal 610 to determine the selected tones 604-1 to 604-N. The selected tones 604-1 to 604-N can improve performance of audioplethysmography 110 during the measurement procedure. To determine the selected tones 604-1 to 604-N, the calibration module 422 extracts the amplitude and/or phase of the pre-processed signal 610 using the amplitude detector and the phase detector, respectively. The quality detector of the calibration module 422 measures quality metrics for each tone (or frequency) of the pre-processed signal 610 and for each of the characteristics (e.g., amplitude and/or phase). Example quality metrics can include peak-to-average ratios and/or signal-to-noise ratios. The peak-to-average ratio represents a peak intensity within a frequency range of interest divided by an average intensity within this frequency range. A higher quality metric indicates a higher-quality signal, or more generally, better performance for audioplethysmography 110.

The comparator of the calibration module 422 can evaluate the quality metrics with respect to a threshold. In an example implementation, the comparator determines the selected tones 604-1 to 604-N for a subsequent measurement procedure based on the frequencies associated with the quality metrics that are greater than or equal to a threshold. Additionally or alternatively, the comparator can evaluate the quality metrics with respect to each other. In an example implementation, the comparator determines one of the selected tones based on a frequency with the highest quality metric across the amplitude. Also, the comparator can determine one of the selected tones 604-1 to 604-N based on a frequency with the highest quality metric across the phase. In other implementations, the comparator can determine a single selected tone based on a frequency having the highest quality metric associated with either the amplitude or the phase.

In general, the calibration module 422 enables the selected tones 604-1 to 604-N to be dynamically adjusted prior to the measurement procedure based on a current environment, which can account for a wear of the hearable 102 (e.g., a current insertion depth and/or rotation), a physical structure of the user 106's ear canal 114, and a response characteristic of the hearable 102 (e.g., speaker, microphone, and/or housing). In this manner, the calibration module 422 can improve the signal-to-noise ratio performance of the hearable 102 for the measurement procedure. The calibration module 422 can also determine which tones 604 generate ultrasound receive signals 504 with desired characteristics for speech recognition 112. In general, the calibration procedure can be performed whether or not the user 106 is speaking.

The calibration module 422 communicates the selected tones 604-1 to 604-N to the speaker 408 using a control signal. The speaker 408 accepts the control signal that identifies the selected tones 604-1 to 604-N and can transmit a subsequent ultrasound transmit signal 502 for speech recognition 112 using the selected tones 604-1 to 604-N. With the calibration procedure, the hearable 102 can dynamically adjust the transmission frequency (e.g., one or more carrier frequencies) each time the seal 116 is formed (e.g., based on the wear of the hearable 102) and based on the unique physical structure of the ear 108. Through this calibration procedure, the hearables 102 on different ears 108 may operate with one or more different ultrasound frequencies.

As part of the measurement procedure, the speech-recognition module 420 can perform aspects of speech recognition 112 using the pre-processed signal 610 to generate a recognized phrase 612. The recognized phrase 612 can include a representation of a phrase 212 that is spoken by the user 106 and is recognized by the speech-recognition module 420. The recognized phrase 612 can be communicated to the computing device 104 (e.g., to the application 306, the voice user interface 202, and/or the voice authenticator 308). Additionally or alternatively, the recognized phrase 612 can be used to control an operation of the hearable 102 and/or the computing device 104.

In FIG. 6, the calibration procedure and the measurement procedure are described as individual procedures that occur at different time intervals. In particular, the calibration procedure occurs before the measurement procedure. This enables the ultrasound transmit signal 502 for the measurement procedure to be transmitted with fewer tones than the ultrasound transmit signal 502 used for the calibration procedure, which can increase signal-to-noise ratio performance for audioplethysmography 110. In some implementations, however, the hearable 102 can have sufficient output power to perform the measurement procedure with the multiple tones 602-1 to 602-M using a single ultrasound transmit signal 502. In this case, aspects of the calibration module 422 can be integrated within the pre-processing module 418 via a frequency selector. This frequency selector can effectively pass the selected tones 604-1 to 604-N to the speech-recognition module 420.

In some implementations, the microphone 410 (or another microphone not shown) can perform passive audio sensing to detect an over-the-air audible signal 614 during the measurement process. The over-the-air audible signal 614 can include the user 106's speech as well as any noise that is present within the external environment. During passive audio sensing, the microphone 410 generates an audio receive signal 616, which can include the audible speech of the user 106. With the audio receive signal 616, the speech-recognition module 420 can perform ultrasound-fusion speech recognition based on the pre-processed signal 610 and the audio receive signal 616.

If the user 106 speaks (silently or audibly) during a time that the ultrasound receive signal 504 is received, the ultrasound receive signal 504 and any signal derived from it (e.g., the pre-processed signal 610) can include information that is correlated with the speech. This information is referred to as a voice component and can be associated with frequencies above 100 Hz. In general, the voice component within the ultrasound receive signal 504 can be similar to, but orthogonal to, the voice component that is present within the audio receive signal 616. This is because the voice component within the ultrasound receive signal 504 is caused by a different physical phenomenon involving the deformation of the ear canal 114. In contrast, the voice component within the audio receive signal 616 is caused by the passage of air through the body, the shape of the user 106's mouth, the force of aspiration, or the movement of the tongue. With the voice component, the user 106's speech can be reconstructed solely using the pre-processed signal 610. Alternatively, the orthogonality of the voice component enables speech recognition 112 to be enhanced by using a combination of the pre-processed signal 610 and the audio receive signal 616.

The ultrasound receive signal 504 can also include other contextual information that can enhance speech recognition 112 compared to techniques that rely solely on passive audio sensing. This information is referred to as a contextual component and can be associated with frequencies below 100 Hz (e.g., sub-100 Hz frequencies) and/or frequencies that are significantly above 100 Hz. The contextual component can represent movements that the user 106 performs in order to speak, such as jaw and/or tongue movements. Additionally or alternatively, the contextual component can represent additional movements that the user 106 performs while speaking, such as blinking, rolling their eyes, or shaking their head. The contextual component can also include information regarding the user 106's respiration rate and/or heart rate.

### Speech Recognition

FIG. 7 illustrates an example implementation of the speech-recognition module 420 for performing speech recognition 112 using active acoustic sensing. In the depicted configuration, the speech-recognition module 420 optionally includes a denoising filter 702. The speech-recognition module 420 also includes at least one input formatter 704, at least one machine-learned model 706, and at least one decoder 708. In this example, the speech-recognition module 420 is implemented using the machine-learned model 706. Other examples are also possible in which the speech-recognition module 420 uses other signal processing and/or data analysis techniques.

The denoising filter 702 performs aspects of external-noise-source filtering and/or internal-noise-source filtering. External-noise-source filtering involves attenuating interference that is present within an external environment (e.g., a noisy environment). This interference can include any of the noise sources described with respect to FIG. 2. During operation, this noise can be unintentionally modulated onto or mixed with the ultrasound receive signal 504. This interference can occur due to non-linearities in the microphone 410, intermodulation distortion, harmonics, a mixing operation performed by the hearable 102, or some other component and/or operation of the hearable 102.

Internal-noise-source filtering involves attenuating interference within the ultrasound receive signal 504 to improve sensitivity and accuracy for audioplethysmography 110. This interference can be caused by the hearable 102 performing other operations (e.g., rendering audio content, performing active-noise cancellation, or operating in accordance with a transparency mode). The performance improvement associated with internal-noise-source filtering enables audioplethysmography 110 to be performed while the hearable performs these other operations. Furthermore, it improves the ability of audioplethysmography 110 to be used for speech recognition 112.

Generally speaking, the denoising filter 702 attenuates noise that is present within the pre-processed signal 610 such that a voice component associated with the user 106's speech is enhanced (or amplified relative to a noise level). In this way, the denoising filter 702 can increase sensitivity for performing speech recognition 112. Generally speaking, the voice component is superimposed onto the ultrasound receive signal 504 and is correlated with the audio receive signal 616. The voice component is uncorrelated with the noise component.

The denoising filter 702 can be implemented using at least one internal-noise-source filter 710 (INS filter 710) and/or at least one external-noise-source filter 712 (ENS filter 712). The internal-noise-source filter 710 performs internal-noise-source filtering and can be implemented using at least two adaptive filters. The adaptive filters can apply various adaptive filtering techniques, including techniques based on least mean squares (LMS) or recursive least squares (RLS). A first adaptive filter performs adaptive filtering using a noise signal (e.g., a self-generated noise signal) as a noise reference to attenuate an internal-noise-source component within the pre-processed signal 610. Likewise, a second adaptive filter performs adaptive filtering using the noise signal as a noise reference to attenuate the internal-noise-source component within the audio receive signal 616. In this example, the noise signal is not correlated with the desired voice component within the pre-processed signal 610 and/or the audio receive signal 616. As such, the noise signal can be used as a reference signal to attenuate the internal noise component within the pre-processed signal 610 and/or the audio receive signal 616 using adaptive filtering techniques. The noise signal can represent audio content that is rendered by the speaker 408 (or another speaker). Example types of audio content can include music, a human voice, or some other type of sound. Additionally or alternatively, the noise signal can represent an anti-noise signal that is generated by the active-noise-cancellation circuit 424 for active noise cancellation and/or a transparency-mode signal that amplifies sound from an external environment in accordance with a transparency mode of the hearable 102.

The external-noise-source filter 712 performs external-noise-source filtering and can be implemented using at least one adaptive filter and/or at least one blind-source separator. The adaptive filter performs adaptive filtering using the audio receive signal 616 as a reference to filter a noise component from the pre-processed signal 610. Similarly, the blind-source separator performs blind-source separation (BSS) using the audio receive signal 616 as a reference to filter the noise component from the pre-processed signal 610. Explained another way, adaptive filtering and/or blind-source separation utilize the audio receive signal 616 to separate a voice component from the noise component within the pre-processed signal 610. To perform adaptive filtering or blind-source separation, the pre-processed signal 610 represents a primary reference (e.g., the primary channel or the signal to be filtered) and the audio receive signal 616 represents a secondary or a noise reference (e.g., the reference channel).

The input formatter 704 appropriately formats one or more signals that are passed as inputs to the machine-learned model 706. The input formatter 704 can be implemented using at least one spectrogram generator 714. In some implementations, the input formatter 704 also includes a stacker 716. The spectrogram generator 714 and the stacker 716 are further explained below.

The machine-learned model 706 is implemented using one or more neural networks. A neural network includes a group of connected nodes (e.g., neurons or perceptrons), which are organized into one or more layers. As an example, the machine-learned model 706 includes a deep neural network, which includes an input layer, an output layer, and one or more hidden layers positioned between the input layer and the output layers. The nodes of the deep neural network can be partially-connected or fully-connected between the layers.

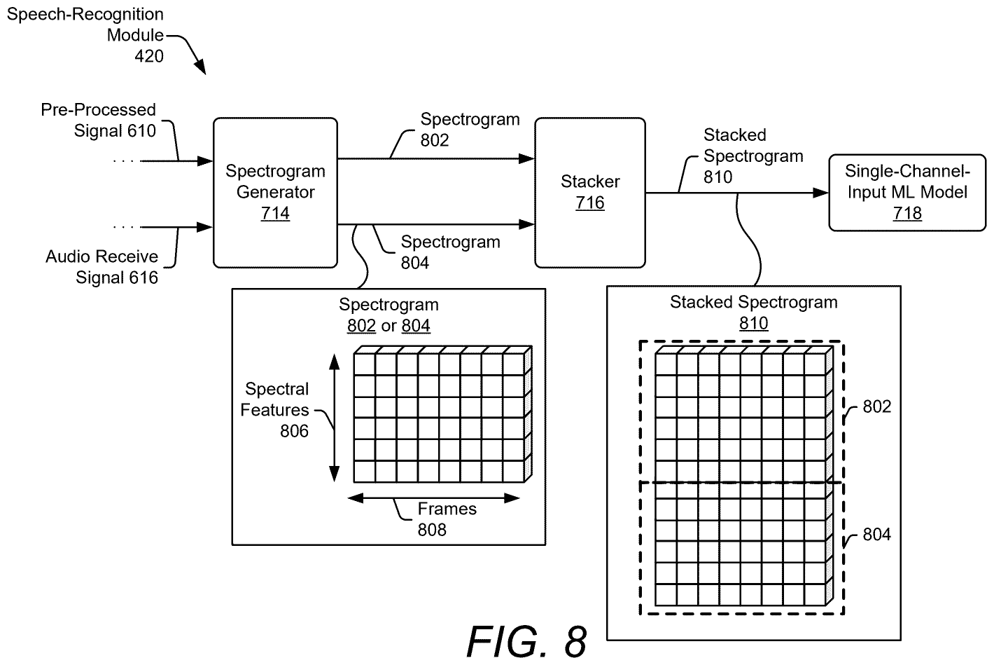

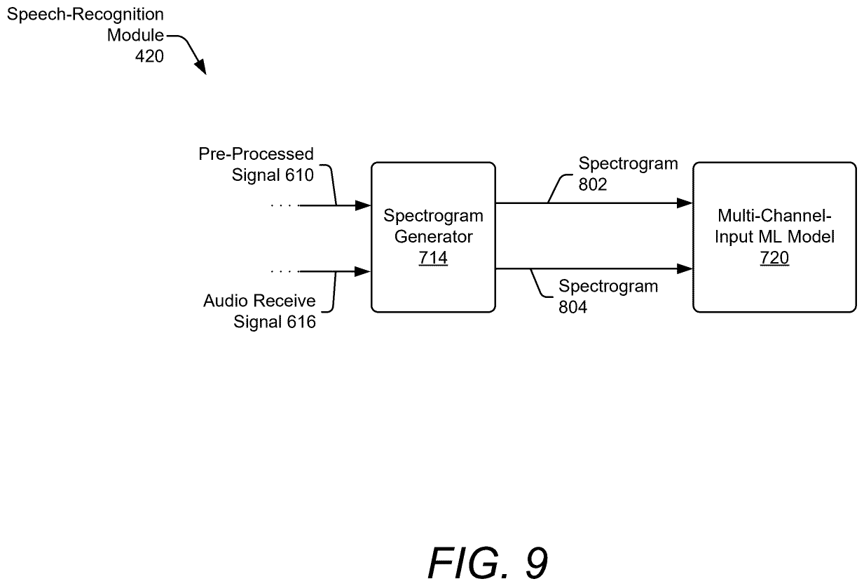

In some implementations, the neural network is a recurrent neural network (e.g., a long short-term memory (LSTM) neural network) with connections between nodes forming a cycle to retain information from a previous portion of an input data sequence for a subsequent portion of the input data sequence. In other cases, the neural network is a feed-forward neural network in which the connections between the nodes do not form a cycle. Additionally or alternatively, the machine-learned model 706 includes another type of neural network, such as a convolutional neural network. The machine-learned model 706 can also include one or more types of regression models, such as a single linear regression model, multiple linear regression models, logistic regression models, step-wise regression models, multi-variate adaptive regression splines, locally estimated scatterplot smoothing models, and so forth. In example implementations, the machine-learned model 706 can be implemented using a single-channel-input machine-learned model 718 or a multi-channel-input machine-learned model 720, as further described with respect to FIGS. 8 and 9.

In general, the machine-learned model 706 is trained using supervised learning to extract features from at least a version of the ultrasound receive signal 504 such that the features can be used to recognize at least one spoken phrase 212. The supervised learning can use simulated (e.g., synthetic) data or measured (e.g., real) data for training purposes. Features that are extracted by the machine-learned model 706 are passed to the decoder 708.

The decoder 708 uses these extracted features to generate the recognized phrase 612. The decoder 708 can utilize an acoustic model, a dictionary, and/or a language model to generate the recognized phrase 612. In some cases, the recognized phrase 612 can be a transcript of the recognized phrase. In other cases, the recognized phrase 612 can be some type of digital information or signal that represents the phrase 212.

Consider an example implementation that includes the denoising filter 702. During an operation of the hearable 102, the denoising filter 702 generates at least one filtered signal 722 by filtering the pre-processed signal 610 and/or the audio receive signal 616 using the techniques described above with respect to internal-noise-source filtering and/or external-noise-source filtering. The input formatter 704 generates at least one spectrogram 724 based on the filtered signal 722. Generally speaking, the input formatter 704 generates an output that represents an input signal in a frequency vs time domain. In an example implementation, the spectrogram generator 714 applies a Fourier transform to generate a spectrogram 724 of the filtered signal 722. A spectrogram 724 includes amplitudes associated with each frequency that is present in the filtered signal 722 across multiple time segments. The machine-learned model 706 generates a feature vector 726 based on the spectrogram 724. The decoder 708 generates the recognized phrase 612 based on the feature vector 726.

Other implementations of the speech-recognition module 420 can pass the audio receive signal 616 (or a filtered version thereof) to the input formatter 704. The one or more spectrograms 724 that are provided to the machine-learned model 706 can include a spectrogram 724 of the audio receive signal 616. Example implementations of a speech-recognition module 420 that utilizes both the pre-processed signal 610 and the audio receive signal 616 are further described with respect to FIGS. 8 and 9.

FIG. 8 illustrates a first example implementation of the speech-recognition module 420. In the depicted configuration, the speech-recognition module 420 includes the spectrogram generator 714, the stacker 716, and the single-channel-input machine-learned model 718. The single-channel-input machine-learned model 718 can be implemented using a convolutional neural network or a single-channel transformer with a convolutional layer.

During operation, the spectrogram generator 714 generates spectrograms 802 and 804 of the pre-processed signal 610 and the audio receive signal 616, respectively. The spectrograms 802 and 804 include spectral features 806 (e.g., amplitudes associated with different frequencies) across multiple frames 808. The stacker 716 combines the spectrograms 802 and 804 together to generate a stacked spectrogram 810. In this example, the spectrogram 802 is stacked “on top of” the spectrogram 804. Generally speaking, the stacker 716 concatenates the spectrogram 802 and the spectrogram 804 in some manner to generate the stacked spectrogram 810. In this sense, the spectrogram 804 augments the feature size of the information provided to the single-channel-input machine-learned model 718.

FIG. 9 illustrates a second example implementation of the speech-recognition module 420. In the depicted configuration, the speech-recognition module 420 includes the spectrogram generator 714 and the multi-channel-input machine-learned model 720. The multi-channel-input machine-learned model 720 can be implemented using a multiple-input convolutional neural network or a multi-channel transformer having multiple separate convolutional layers. In this example, the spectrograms 802 and 804 are provided as independent or separate inputs to the multi-channel-input machine-learned model 720. This enables the multi-channel-input machine-learned model 720 to compute the self and cross channel correlation, which enables it to further exploit the similarities and differences between the channels for speech recognition 112.

The example implementations shown in FIGS. 8 and 9 can support ultrasound-fusion speech recognition. Also, the implementations shown in FIGS. 8 and 9 can perform ultrasound-based speech recognition during situations in which the audio receive signal 616 does not include the voice component because the phrase 212 is spoken silently by the user 106. Other implementations are also possible. If the speech-recognition module 420 is designed to support ultrasound-based speech recognition without supporting ultrasound-fusion speech recognition, the speech-recognition module 420 can be implemented using a spectrogram generator 714 and the single-channel-input ML model 718. In this case, the speech-recognition module 420 can be implemented without the stacker 716.

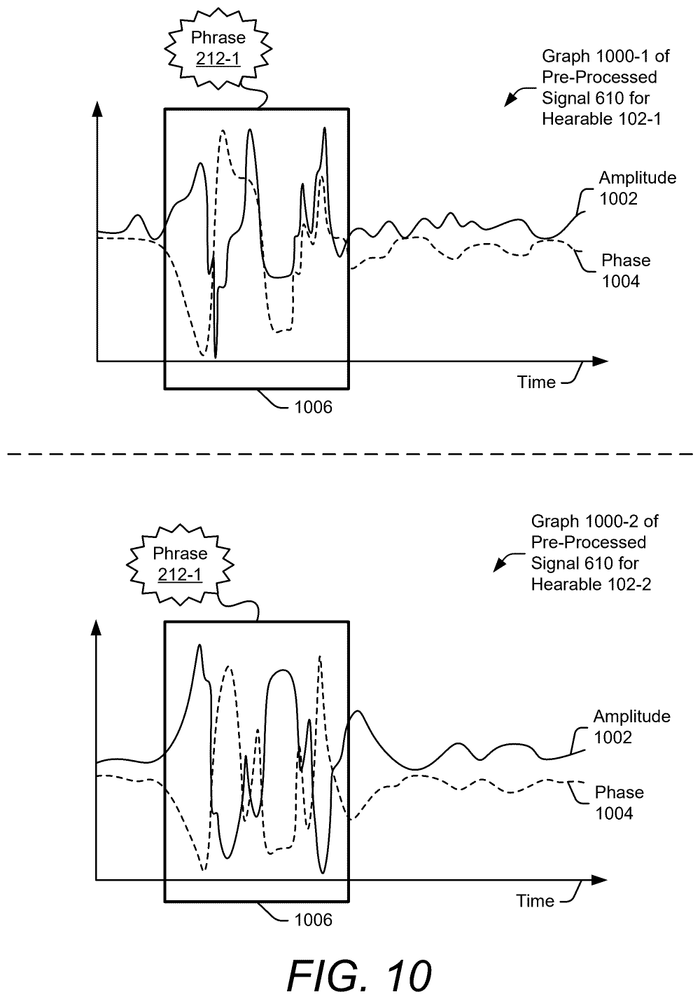

FIGS. 10-12 illustrate the impact of a spoken phrase 212 on an ultrasound receive signal 504. More specifically, FIGS. 10-12 depict example amplitudes and phases of pre-processed signals 610 generated by different hearables 102-1 and 102-2. As shown below, the pressure wave caused by a spoken phrase 212 can significantly impact the amplitude and/or the phase of the pre-processed signals 610. In some instances, the change in the amplitude and/or the phase can be relative to a previous state or relative to a previous trend in the amplitude and/or the phase. The previous state can refer to values of the amplitude and/or the phase during which the user 106 does not speak.

In general, the term “significantly” can mean that the values of the amplitude and/or the phase can change by 20% or more relative to a previous value (e.g., relative to an average of a set of previous values). Additionally or alternatively, a slope of the amplitude and/or the phase can vary significantly. Sometimes the slope of the amplitude and/or the phase can change signs (e.g., from a positive slope to a negative slope, or vice versa). A magnitude of the slope of the amplitude and/or the phase can sometimes change by approximately 10% or more.

In some implementations, the speech-recognition module 420 can detect and recognize the phrase 212 based on the amplitude of the pre-processed signal 610 provided by the hearable 102-1, the phase of the pre-processed signal 610 provided by the hearable 102-1, the amplitude of the pre-processed signal 610 provided by the hearable 102-2, the phase of the pre-processed signal 610 provided by the hearable 102-2, or some combination thereof. Generally speaking, processing a larger quantity of signals and/or tones 604 that are sensitive to the pressure wave caused by the spoken phrase 212 provides more information to the speech-recognition module 420. This can make it easier for the speech-recognition module 420 to accurately perform speech recognition 112.

Graphs 1000-1 and 1000-2 in FIG. 10 depict amplitudes 1002 and phases 1004 of pre-processed signals 610 that are respectively generated by the hearables 102-1 and 102-2. Time is depicted along the horizontal axes of the graphs 1000-1 and 1000-2.

During the time interval indicated at 1006, the user 106 speaks a first phrase 212-1 (e.g., audibly speaks, silently speaks, hums, whistles, sings, or makes other utterances). This causes the amplitude 1002 and/or the phase 1004 of the ultrasound receive signal 504 to change significantly relative to a previous state. With audioplethysmography 110, the speech-recognition module 420 can detect and recognize the phrase 212 based on the change in the amplitude 1002 and/or phase 1004 of the pre-processed signals 610 provided by the hearable 102-1 and/or the hearable 102-2.

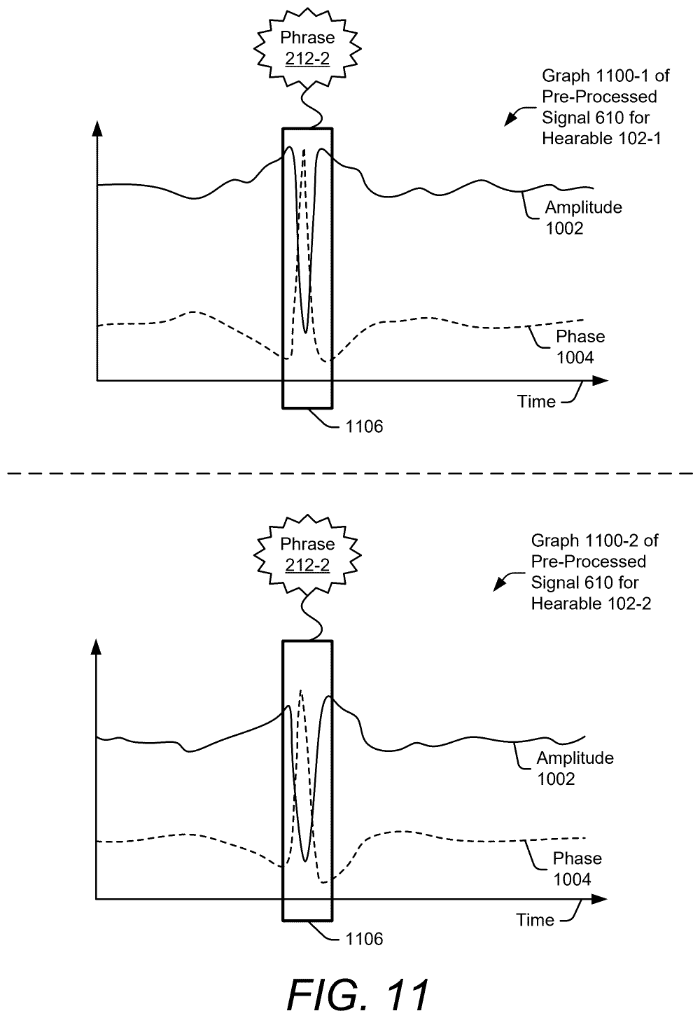

Graphs 1100-1 and 1100-2 in FIG. 11 depict amplitudes 1002 and phases 1004 of pre-processed signals 610 that are respectively generated by the hearables 102-1 and 102-2. Time is depicted along the horizontal axes of the graphs 1100-1 and 1100-2.

During the time interval indicated at 1106, the user 106 speaks a second phrase 212-2 (e.g., audibly speaks, silently speaks, hums, whistles, sings, or makes other utterances). This causes the amplitude 1002 and/or the phase 1004 of the ultrasound receive signal 504 to change significantly relative to a previous state. With audioplethysmography 110, the speech-recognition module 420 can detect and recognize the phrase 212 based on the change in the amplitude 1002 and/or phase 1004 of the pre-processed signals 610 provided by the hearable 102-1 and/or the hearable 102-2.

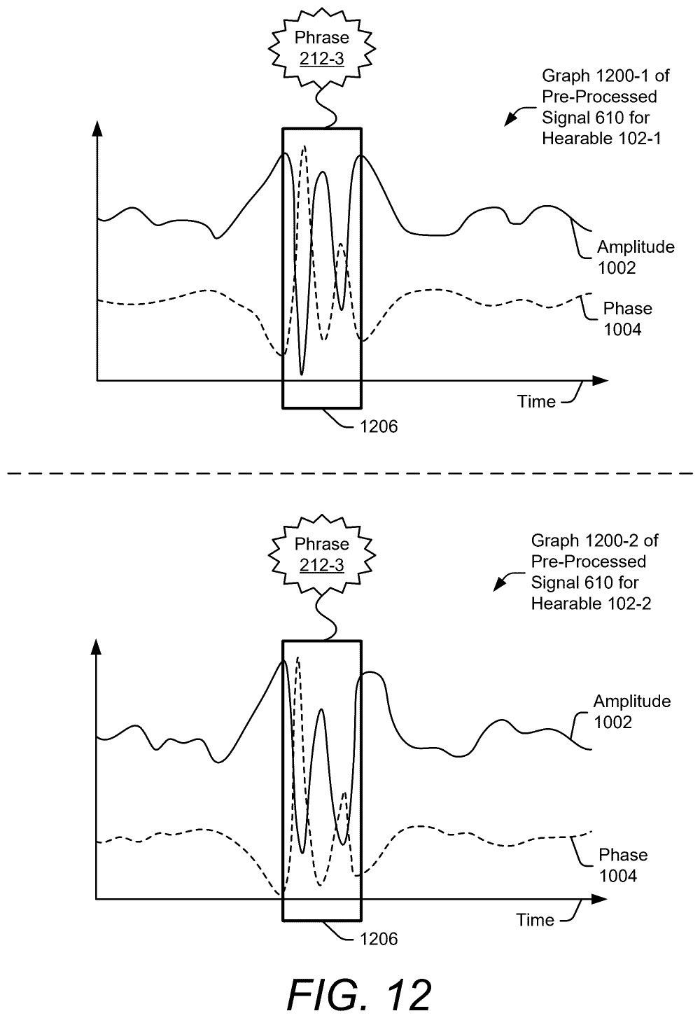

Graphs 1200-1 and 1200-2 in FIG. 12 depict amplitudes 1002 and phases 1004 of pre-processed signals 610 that are respectively generated by the hearables 102-1 and 102-2. Time is depicted along the horizontal axes of the graphs 1200-1 and 1200-2.

During the time interval indicated at 1206, the user 106 speaks a third phrase 212-3 (e.g., audibly speaks, silently speaks, hums, whistles, sings, or makes other utterances). This causes the amplitude 1002 and/or the phase 1004 of the ultrasound receive signal 504 to change significantly relative to a previous state. With audioplethysmography 110, the speech-recognition module 420 can detect and recognize the phrase 212 based on the change in the amplitude 1002 and/or phase 1004 of the pre-processed signals 610 provided by the hearable 102-1 and/or the hearable 102-2.

As seen in FIGS. 10-12, different phrases 212-1 to 212-3 can cause the amplitude 1002 and/or phase 1004 of the pre-processed signal 610 to vary in different ways. This further enables the speech-recognition module 420 to recognize more than one phrase 212.

Aspects of speech recognition 112 can be performed using one hearable 102 (e.g., the hearable 102-1 or 102-2) or multiple hearables 102 (e.g., the hearables 102-1 and 102-2). With multiple hearables 102 performing speech recognition 112, the computing device 104 can have higher confidence that the user 106's spoken phrase 212 is recognized. In general, the hearable 102 can recognize speech by analyzing changes in the amplitude 1002 of the ultrasound receive signal 504, changes in the phase 1004 of the ultrasound receive signal 504, or changes in both the amplitude 1002 and phase 1004 of the ultrasound receive signal 504.

### Example Methods

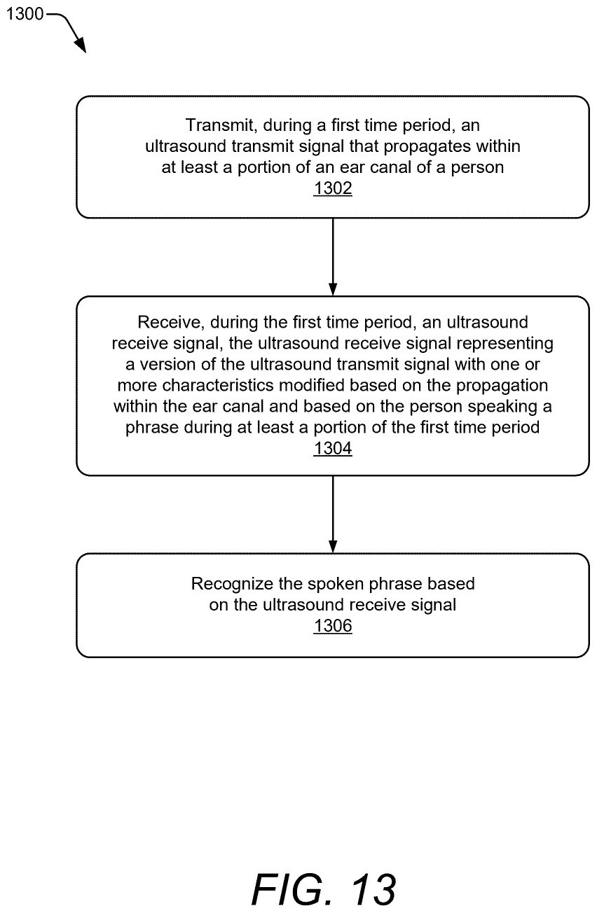

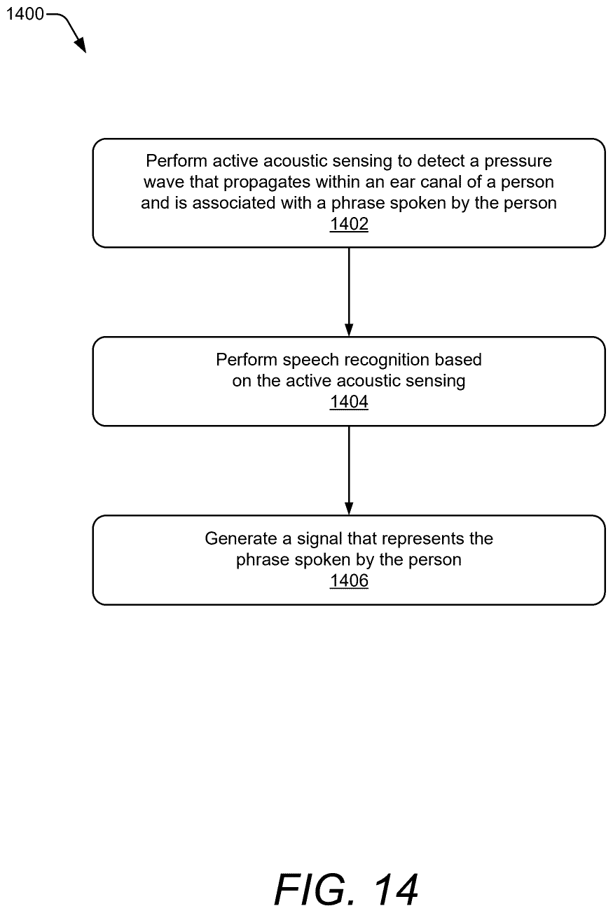

FIGS. 13 and 14 depict example methods 1300 and 1400 for implementing aspects of speech recognition 112 using active acoustic sensing. Methods 1300 and 1400 are shown as sets of operations (or acts) performed but not necessarily limited to the order or combinations in which the operations are shown herein. Further, any of one or more of the operations may be repeated, combined, reorganized, or linked to provide a wide array of additional and/or alternate methods. In portions of the following discussion, reference may be made to the environments 100 and 200 of FIGS. 1 and 2, and entities detailed in FIGS. 3 and 4, reference to which is made for example only. The techniques are not limited to performance by one entity or multiple entities operating on one device.

At 1302, an ultrasound transmit signal is transmitted during a first time period. The ultrasound transmit signal propagates within at least a portion of an ear canal of a person. For example, the transducer 406 (or speaker 408) of the hearable 102 transmits the ultrasound transmit signal 502. The ultrasound transmit signal 502 propagates within at least a portion of the ear canal 114 of a person (e.g., the user 106), as described with respect to FIG. 5.

At 1304, an ultrasound receive signal is received. The ultrasound receive signal represents a version of the ultrasound transmit signal with one or more waveform characteristics modified based on the propagation within the ear canal and based on the person speaking a phrase during at least a portion of the first time period. For example, the transducer 406 (or the microphone 410) of the hearable 102 receives the ultrasound receive signal 504. The ultrasound receive signal 504 represents a version of the ultrasound transmit signal 502 with one or more waveform characteristics modified based on the propagation within the ear canal 114 and based on the user 106 speaking a phrase 212 during at least a portion of the first time period. The user 106 can speak the phrase 212 by audibly speaking, silently speaking, humming, singing, whispering, shouting, and so forth.

The hearable 102 that receives the ultrasound receive signal 504 can be a same hearable 102 that transmitted the ultrasound transmit signal 502 (e.g., the hearable 102-1 or 102-2 in FIG. 5), or another hearable 102 that did not transmit the ultrasound transmit signal 502 (e.g., the hearable 102-2 in FIG. 5). Example waveform characteristics include amplitude, phase, and/or frequency. In some implementations, a feedback microphone of an active-noise-cancellation circuit 424 can receive the ultrasound receive signal 504.

At 1306, the spoken phrase is recognized based on the ultrasound receive signal. For example, the hearable 102 uses the speech-recognition module 420 to analyze the one or more modified characteristics of the ultrasound receive signal 504 and recognize the spoken phrase 212. The hearable 102 can generate a recognized phrase 612, which can be used to control an operation of the hearable 102 and/or an operation of the computing device 104. The recognized phrase 612 represents and/or identifies the phrase 212 that is spoken by the user 106. In some implementations, the spoken phrase is recognized using a combination of the ultrasound receive signal 504 and an audio receive signal 616 that is provided by passive audio sensing.

At 1402 in FIG. 14, active acoustic sensing is performed to detect a pressure wave that propagates within an ear canal of a person and is associated with a phrase that is spoken by the person. For example, the hearable 102 performs active acoustic sensing to detect a pressure wave that propagates within an ear canal 114 of a user 106 and is associated with a phrase 212 that is spoken by the user 106. To perform active acoustic sensing, the hearable 102 transmits and receives an ultrasound signal (e.g., the ultrasound transmit signal 502 and the ultrasound receive signal 504). The ultrasound receive signal 504 includes a voice component, which enables audioplethysmography 110 to perform speech recognition 112.

At 1404, speech recognition is performed based on the active acoustic sensing. For example, the hearable 102 performs speech recognition 112 based on the active acoustic sensing. More specifically, the hearable 102 analyzes a spectrogram of the ultrasound receive signal 504 to recognize the phrase 212. In some implementations, the hearable 102 can perform speech recognition 112 using a combination of the ultrasound receive signal 504 and the received audio signal 614.

At 1406, a signal that represents the phrase spoken by the person is generated. For example, the speech-recognition module 420 generates the recognized phrase 612, which represents the phrase 212 that is spoken by the user 106. In some implementations, this recognized phrase 612 controls an operation of at least one of the hearable 102 or the computing device 104 that is coupled to the hearable 102 is generated.

### Example Computing System

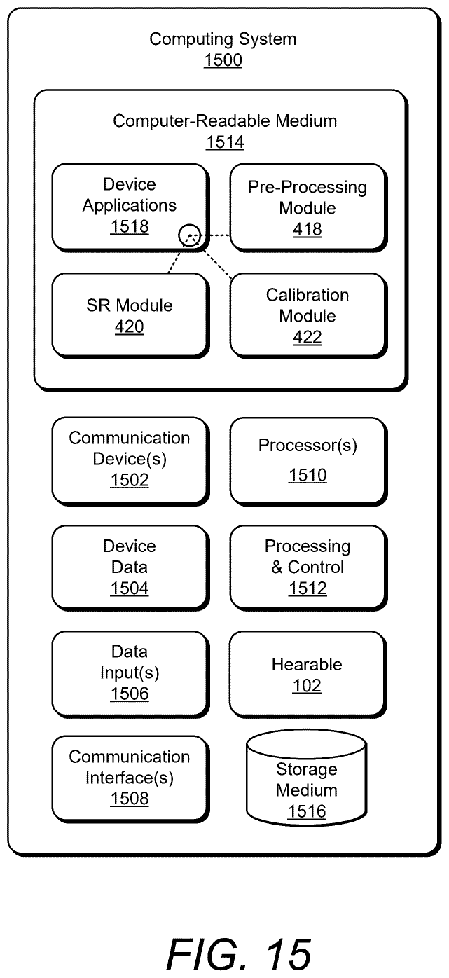

FIG. 15 illustrates various components of an example computing system 1500 that can be implemented as any type of client, server, and/or computing device as described with reference to the previous FIGS. 3 and 4 to implement aspects of active acoustic sensing using a hearable 102.

The computing system 1500 includes communication devices 1502 that enable wired and/or wireless communication of device data 1504 (e.g., received data, data that is being received, data scheduled for broadcast, or data packets of the data). The communication devices 1502 or the computing system 1500 can include one or more hearables 102. The device data 1504 or other device content can include configuration settings of the device, media content stored on the device, and/or information associated with a user of the device. Media content stored on the computing system 1500 can include any type of audio, video, and/or image data. The computing system 1500 includes one or more data inputs 1506 via which any type of data, media content, and/or inputs can be received, such as human utterances, user-selectable inputs (explicit or implicit), messages, music, television media content, recorded video content, and any other type of audio, video, and/or image data received from any content and/or data source.

The computing system 1500 also includes communication interfaces 1508, which can be implemented as any one or more of a serial and/or parallel interface, a wireless interface, any type of network interface, a modem, and as any other type of communication interface. The communication interfaces 1508 provide a connection and/or communication links between the computing system 1500 and a communication network by which other electronic, computing, and communication devices communicate data with the computing system 1500.

The computing system 1500 includes one or more processors 1510 (e.g., any of microprocessors, controllers, and the like), which process various computer-executable instructions to control the operation of the computing system 1500. Alternatively or in addition, the computing system 1500 can be implemented with any one or combination of hardware, firmware, or fixed logic circuitry that is implemented in connection with processing and control circuits which are generally identified at 1512. Although not shown, the computing system 1500 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

The computing system 1500 also includes a computer-readable medium 1514, such as one or more memory devices that enable persistent and/or non-transitory data storage (i.e., in contrast to mere signal transmission), examples of which include random access memory (RAM), non-volatile memory (e.g., any one or more of a read-only memory (ROM), flash memory, EPROM, EEPROM, etc.), and a disk storage device. The disk storage device may be implemented as any type of magnetic or optical storage device, such as a hard disk drive, a recordable and/or rewriteable compact disc (CD), any type of a digital versatile disc (DVD), and the like. The computing system 1500 can also include a mass storage medium device (storage medium) 1516.

The computer-readable medium 1514 provides data storage mechanisms to store the device data 1504, as well as various device applications 1518 and any other types of information and/or data related to operational aspects of the computing system 1500. For example, an operating system 1520 can be maintained as a computer application with the computer-readable medium 1514 and executed on the processors 1510. The device applications 1518 may include a device manager, such as any form of a control application, software application, signal-processing and control module, code that is native to a particular device, a hardware abstraction layer for a particular device, and so on.

The device applications 1518 also include any system components, engines, or managers to implement audioplethysmography 110 for speech recognition 112. In this example, the device applications 1518 include the pre-processing module 418, the speech-recognition module 420 (SR module 420), and optionally the calibration module 422. Although not explicitly shown, the device applications 1518 can also include the application 306, the voice user interface 202, and/or the voice authenticator 308.

Throughout this disclosure, examples are described where a computing system 1500 (e.g., the hearable 102, the computing device 104, a client device, a server device, a computer, or another type of computing system) may analyze information (e.g., various audible and/or ultrasound signals) associated with a user 106, for example, the phrase 212 mentioned with respect to FIG. 2. Further to the descriptions above, a user 106 may be provided with controls allowing the user 106 to make an election as to both if and when systems, programs, and/or features described herein may enable collection of information (e.g., information about a user 106's social network, social actions, social activities, profession, a user 106's preferences, a user 106's current location), and if the user 106 is sent content or communications from a server. The computing system 1500 can be configured to only use the information after the computing system 1500 receives explicit permission from the user 106 to use the data. For example, in situations where the hearable 102 analyzes signals to recognize the user 106's speech, individual users 106 may be provided with an opportunity to provide input to control whether programs or features of the computing system 1500 can collect and make use of the data. Further, individual users 106 may have constant control over what programs can or cannot do with the information.

In addition, information collected may be pre-treated in one or more ways before it is transferred, stored, or otherwise used, so that personally-identifiable information is removed. For example, before the computing system 1500 shares data with another device, a user 106's identity may be treated so that no personally identifiable information can be determined for the user 106. Thus, the user 106 may have control over whether information is collected about the user 106 and the user 106's device, and how such information, if collected, may be used by the computing system 1500 and/or a remote computing system.

### CONCLUSION

Although techniques using, and apparatuses including, performing speech recognition using active acoustic sensing have been described in language specific to features and/or methods, it is to be understood that the subject of the appended examples is not necessarily limited to the specific features or methods described. Rather, the specific features and methods are disclosed as example implementations of performing speech recognition using active acoustic sensing.

Some examples are described below:

Example 1: A method comprising:
transmitting, during a first time period, an ultrasound transmit signal that propagates within at least a portion of an ear canal of a person;
receiving, during the first time period, an ultrasound receive signal, the ultrasound receive signal representing a version of the ultrasound transmit signal with one or more characteristics modified based on the propagation within the ear canal and based on the person speaking a phrase during at least a portion of the first time period; and
recognizing the spoken phrase based on the ultrasound receive signal.

Example 2: The method of example 1, further comprising at least one of the following:
generating a control signal that controls an operation of a device based on the spoken phrase; or
generating text based on the spoken phrase.

Example 3: The method of example 2, wherein:
the device comprises a hearable;
the transmitting of the ultrasound transmit signal comprises transmitting the ultrasound transmit signal using the hearable; and
the receiving of the ultrasound receive signal comprises receiving the ultrasound receive signal using the hearable.

Example 4: The method of example 2, wherein:
the device comprises a computing device that is coupled to a hearable;
the transmitting of the ultrasound transmit signal comprises transmitting the ultrasound transmit signal using the hearable; and
the receiving of the ultrasound receive signal comprises receiving the ultrasound receive signal using the hearable.

Example 5: The method of any previous example, further comprising:
receiving an audio signal comprising the spoken phrase; and
wherein the recognizing of the spoken phrase comprises recognizing the spoken phrase based on the ultrasound receive signal and the audio signal.

Example 6: The method of example 5, wherein the recognizing of the spoken phrase further comprises:
generating a first spectrogram of a signal derived from the ultrasound receive signal;
generating a second spectrogram of the audio signal; and
generating a feature vector using a machine-learned model by providing the machine-learned model the first spectrogram and the second spectrogram; and
recognizing the spoken phrase based on the feature vector.

Example 7: The method of example 6, further comprising:
generating a stacked spectrogram comprising a combination of the first spectrogram and the second spectrogram,
wherein the generating of the feature vector comprises generating the feature vector using the machine-learned model by providing the machine-learned model the stacked spectrogram as an input.

Example 8: The method of example 7, wherein the machine-learned model comprises:
a convolutional neural network; or
a single-channel transformer having a convolutional layer.

Example 9: The method of example 6, wherein:
the generating of the feature vector comprises generating the feature vector using the machine-learned model by providing the first spectrogram and the second spectrogram as separate inputs to the machine-learned model; and
the machine-learned model comprises:
   a multiple-input convolutional neural network; or
   a multi-channel transformer comprising separate convolutional layers.

Example 10: The method of any previous example, wherein the spoken phrase is silently spoken by the person during at least the portion of the first time period.

Example 11: The method of any previous example, further comprising:
transmitting, prior to the transmitting of the ultrasound transmit signal, another ultrasound transmit signal that propagates within at least the portion of the ear canal of the person, the other ultrasound transmit signal having multiple tones;
receiving, prior to the transmitting of the ultrasound transmit signal, another ultrasound receive signal, the other ultrasound receive signal representing a version of the other ultrasound transmit signal with one or more characteristics modified due to the propagation within the ear canal;
generating quality metrics that respectively correspond to the multiple tones, the quality metrics based on amplitudes and/or phases of the multiple tones; and
selecting at least two tones from the multiple tones based on the quality metrics corresponding to the at least two tones being greater than a threshold,
wherein the transmitting of the ultrasound transmit signal comprises transmitting the ultrasound transmit signal having the at least two tones.

Example 12: The method of example 11, wherein the transmitting of the ultrasound transmit signal comprises at least one of the following:
transmitting the ultrasound transmit signal such that the ultrasound transmit signal has a higher amplitude at the at least two tones compared to an amplitude of the other ultrasound transmit signal at the multiple tones; or
transmitting the ultrasound signal such that a duration of ultrasound transmit signal at each of the at least two tones is longer compared to a duration of the other ultrasound transmit signal at each of the multiple tones.

Example 13: The method of any previous example, wherein the recognizing of the spoken phrase comprises recognizing the spoken phrase using the ultrasound receive signal and without using one or more of the following:
an audio signal that includes the spoken phrase and is captured using passive audio sensing; or
another signal obtained from another sensor of the hearable that is different from an ultrasound sensor.

Example 14: The method of any previous example, further comprising:
rendering audible content during the first time period, the rendering causing an audible signal to propagate within at least a portion of the ear canal of the person.

Example 15: The method of any previous example, wherein:
the rendering of the audible content comprises transmitting, during the first time period, audible signal that propagates within at least a portion of the ear canal of the person;
the ultrasound receive signal comprises an internal noise component caused by interference generated by the rendering of the audible signal;
the method further comprises generating a denoised signal by filtering the internal noise component within the ultrasound receive signal based on a version of the audible signal; and
the recognizing of the spoken phrase comprises recognizing the spoken phrase based on the denoised signal.

Example 16: A non-transitory computer-readable storage medium comprising instructions that, responsive to execution by a processor, cause a hearable to perform any one of the methods of examples 1 to 15.

Example 17: A device comprising:
at least one transducer; and
at least one processor, the device configured to perform, using the at least one transducer and the at least one processor, any one of the methods of examples 1 to 15.

Example 18: The device of example 17, further comprising:
a speaker; and
an active-noise-cancellation circuit comprising a feedback microphone,
wherein the at least one transducer comprises the speaker and the feedback microphone.

Example 19: The device of example 17, wherein:
the at least one transducer comprises a speaker and a microphone;
the speaker is configured to be positioned proximate to a first ear of a person; and
the microphone is configured to be positioned proximate to a second ear of the person.

Example 20: The device of any one of examples 17 to 19, wherein the device comprises: at least one earbud.

What is claimed is:

1. A method comprising:
transmitting, during a first time period, an ultrasound transmit signal that propagates within at least a portion of an ear canal of a person;
receiving, during the first time period, an ultrasound receive signal, the ultrasound receive signal representing a version of the ultrasound transmit signal with one or more characteristics modified based on the propagation within the ear canal and based on the person speaking a phrase during at least a portion of the first time period; and
recognizing the spoken phrase based on the ultrasound receive signal.

2. The method of claim 1, further comprising at least one of the following:
generating a control signal that controls an operation of a device based on the spoken phrase; or
generating text based on the spoken phrase.

3. The method of claim 2, wherein:
the device comprises a hearable;
the transmitting of the ultrasound transmit signal comprises transmitting the ultrasound transmit signal using the hearable; and
the receiving of the ultrasound receive signal comprises receiving the ultrasound receive signal using the hearable.

4. The method of claim 2, wherein:
the device comprises a computing device that is coupled to a hearable;
the transmitting of the ultrasound transmit signal comprises transmitting the ultrasound transmit signal using the hearable; and
the receiving of the ultrasound receive signal comprises receiving the ultrasound receive signal using the hearable.

5. The method of claim 1, further comprising:
receiving an audio signal comprising the spoken phrase; and
wherein the recognizing of the spoken phrase comprises recognizing the spoken phrase based on the ultrasound receive signal and the audio signal.

6. The method of claim 5, wherein the recognizing of the spoken phrase further comprises:
generating a first spectrogram of a signal derived from the ultrasound receive signal;
generating a second spectrogram of the audio signal; and
generating a feature vector using a machine-learned model by providing the machine-learned model the first spectrogram and the second spectrogram; and
recognizing the spoken phrase based on the feature vector.

7. The method of claim 6, further comprising:
generating a stacked spectrogram comprising a combination of the first spectrogram and the second spectrogram,
wherein the generating of the feature vector comprises generating the feature vector using the machine-learned model by providing the machine-learned model the stacked spectrogram as an input.

8. The method of claim 7, wherein the machine-learned model comprises:
a convolutional neural network; or
a single-channel transformer having a convolutional layer.

9. The method of claim 6, wherein:
the generating of the feature vector comprises generating the feature vector using the machine-learned model by providing the first spectrogram and the second spectrogram as separate inputs to the machine-learned model; and
the machine-learned model comprises:
a multiple-input convolutional neural network; or
a multi-channel transformer comprising separate convolutional layers.

10. The method of claim 1, wherein the spoken phrase is silently spoken by the person during at least the portion of the first time period.

11. The method of claim 1, further comprising:
transmitting, prior to the transmitting of the ultrasound transmit signal, another ultrasound transmit signal that propagates within at least the portion of the ear canal of the person, the other ultrasound transmit signal having multiple tones;
receiving, prior to the transmitting of the ultrasound transmit signal, another ultrasound receive signal, the other ultrasound receive signal representing a version of the other ultrasound transmit signal with one or more characteristics modified due to the propagation within the ear canal;
generating quality metrics that respectively correspond to the multiple tones, the quality metrics based on amplitudes and/or phases of the multiple tones; and
selecting at least two tones from the multiple tones based on the quality metrics corresponding to the at least two tones being greater than a threshold,
wherein the transmitting of the ultrasound transmit signal comprises transmitting the ultrasound transmit signal having the at least two tones.

12. The method of claim 11, wherein the transmitting of the ultrasound transmit signal comprises at least one of the following:
transmitting the ultrasound transmit signal such that the ultrasound transmit signal has a higher amplitude at the at least two tones compared to an amplitude of the other ultrasound transmit signal at the multiple tones; or
transmitting the ultrasound signal such that a duration of ultrasound transmit signal at each of the at least two tones is longer compared to a duration of the other ultrasound transmit signal at each of the multiple tones.

13. The method of claim 1, wherein the recognizing of the spoken phrase comprises recognizing the spoken phrase using the ultrasound receive signal and without using one or more of the following:
an audio signal that includes the spoken phrase and is captured using passive audio sensing; or
another signal obtained from another sensor that is different from an ultrasound sensor.

14. The method of claim 1, further comprising:
rendering audible content during the first time period, the rendering causing an audible signal to propagate within at least a portion of the ear canal of the person.

15. The method of claim 14, wherein:
the rendering of the audible content comprises transmitting, during the first time period, audible signal that propagates within at least a portion of the ear canal of the person;
the ultrasound receive signal comprises an internal noise component caused by interference generated by the rendering of the audible signal;
the method further comprises generating a denoised signal by filtering the internal noise component within the ultrasound receive signal based on a version of the audible signal; and
the recognizing of the spoken phrase comprises recognizing the spoken phrase based on the denoised signal.

16. A non-transitory computer-readable storage medium comprising instructions that, responsive to execution by a processor, cause a hearable to:
transmit, during a first time period, an ultrasound transmit signal that propagates within at least a portion of an ear canal of a person;
receive, during the first time period, an ultrasound receive signal, the ultrasound receive signal representing a version of the ultrasound transmit signal with one or more characteristics modified based on the propagation within the ear canal and based on the person speaking a phrase during at least a portion of the first time period; and
recognize the spoken phrase based on the ultrasound receive signal.

17. A device comprising:
at least one transducer configured to:
transmit, during a first time period, an ultrasound transmit signal that propagates within at least a portion of an ear canal of a person; and
receive, during the first time period, an ultrasound receive signal, the ultrasound receive signal representing a version of the ultrasound transmit signal with one or more characteristics modified based on the propagation within the ear canal and based on the person speaking a phrase during at least a portion of the first time period; and
at least one processor configured to recognize the spoken phrase based on the ultrasound receive signal.

18. The device of claim 17, further comprising:
a speaker; and
an active-noise-cancellation circuit comprising a feedback microphone,
wherein the at least one transducer comprises the speaker and the feedback microphone.

19. The device of claim 17, wherein:
the at least one transducer comprises a speaker and a microphone;
the speaker is configured to be positioned proximate to a first ear of a person; and
the microphone is configured to be positioned proximate to a second ear of the person.

20. The device of claim 17, wherein the device comprises:
at least one earbud.
